(19) United States
(12) Patent Application Publication
(10) Pub. No.: US 2018/0091088 A1
(43) Pub. Date: Mar. 29, 2018

(54) SYSTEMS AND METHODS FOR ROTATABLY MOUNTING AND LOCKING SOLAR PANELS

(71) Applicant: Alion Energy, Inc., Richmond, CA (US)

(72) Inventors: Nicholas A. BARTON, Richmond, CA (US); Soren JENSEN, Corte Madera, CA (US); Rodney Hans HOLLAND, Novato, CA (US); Graham MAXWELL, Rocklin, CA (US); Timothy WHEELER, Richmond, CA (US)

(21) Appl. No.: 15/643,278

(22) Filed: Jul. 6, 2017

Related U.S. Application Data
(60) Provisional application No. 62/359,959, filed on Jul. 8, 2016.
(60) Provisional application No. 62/406,303, filed on Oct. 10, 2016.
(60) Provisional application No. 62/406,861, filed on Oct. 11, 2016.
(60) Provisional application No. 62/436,945, filed on Dec. 20, 2016.
(60) Provisional application No. 62/508,053, filed on May 18, 2017.

(51) Int. Cl. H02S 20/32; F16H 19/00; F24J 2/54

(52) U.S. Cl. CPC H02S 20/32; F16H 19/001; F24J 2/54; F24J 2002/5288; F24J 2002/5468; F24J 2002/5482; F24J 2002/5462

(57) ABSTRACT

Systems and methods are provided for rotatably mounting and locking solar (e.g., photovoltaic) panels. For example, the solar panels can be mounted so as to be rotatable about an axis so as to track the sun over the course of the day, and can be locked in a suitable position during high-wind conditions. A drive mechanism includes a drive shaft, pinion gear coupled to the drive shaft, and arc gear coupled to a solar panel, and a locking mechanism includes a lock plate coupled to the arc gear and including a reaction surface. The pinion gear includes a bearing surface. When the drive shaft rotates a first amount, engagement between pinion gear teeth and arc gear teeth rotates the arc gear. When the drive shaft rotates a second amount, the arc gear rotates to a stow position where the reaction surface bears against the bearing surface, locking the arc gear.

### CROSS-REFERENCE TO RELATED APPLICATIONS

This application claims the benefit of the following applications, the entire contents of each of which are incorporated by reference herein:

U.S. Provisional Application No. 62/359,959, filed Jul. 8, 2016 and entitled “Systems and Methods for Assembly, Operation, and Maintenance of Photovoltaic Modules;”

U.S. Provisional Application No. 62/406,303, filed Oct. 10, 2016 and entitled “Systems and Methods of Locking Mechanisms for Tracking Photovoltaic Systems;”

U.S. Provisional Application No. 62/406,861, filed Oct. 11, 2016 and entitled “Systems and Methods of Locking Mechanisms for Tracking Photovoltaic Systems;”

U.S. Provisional Application No. 62/436,945, filed Dec. 20, 2016 and entitled “Systems and Methods of Locking Mechanisms for Tracking Photovoltaic Systems;” and

U.S. Provisional Application No. 62/508,053, filed May 18, 2017 and entitled “Systems and Methods for Rotatably Mounting and Locking Solar Panels.”

### FIELD

This application relates to mounting solar panels, such as photovoltaic panels.

### BACKGROUND

It can be useful to rotate arrays of solar modules, such as photovoltaic (PV) modules, e.g., as the sun moves relative to the array over the course of a day. However, rotating multiple solar modules of a given array can be challenging. For example, individually rotating the modules can require providing each module with its own actuator, and appropriately controlling such actuators.

Hence, it is desirable to improve techniques for rotating solar modules.

### SUMMARY

Systems and methods are provided for rotatably mounting and locking solar panels, such as photovoltaic panels.

Under one aspect, a system for rotatably mounting and locking a solar panel includes a drive mechanism and a locking mechanism. The drive mechanism can include a drive shaft, a pinion gear, and an arc gear. The pinion gear can be coupled to the drive shaft and can include pinion gear teeth and a bearing surface. The arc gear can be coupled to the solar panel and can include a first section. The first section can include arc gear teeth. The locking mechanism can include a lock plate that is coupled to the arc gear and that can include a reaction surface. Responsive to rotation of the drive shaft by a first amount, engagement of the pinion gear teeth with the arc gear teeth in the first section can rotate the arc gear. Responsive to rotation of the drive shaft by a second amount, the arc gear can rotate to a stow position at which the reaction surface bears against the bearing surface and locks the arc gear in place.

In some configurations, the locking mechanism optionally further can include a drive pin coupled to the pinion gear; and the lock plate further can include a slot configured to engage the drive pin. Responsive to rotation of the drive shaft by a third amount, the slot of the lock plate can engage with the drive pin responsive to which the arc gear teeth disengage from the pinion gear teeth.

Additionally, or alternatively, in some configurations the arc gear optionally further can include a second section lacking arc gear teeth, the lock plate being coupled adjacent to the second section.

Additionally, or alternatively, some configurations optionally further can include a leg and a bearing mount coupled to the leg, the bearing mount supporting the drive shaft and the pinion gear.

Additionally, or alternatively, in some configurations optionally wherein when the arc gear is at the stow position, bearing of the reaction surface against the bearing surface substantially transmits a wind load on the solar panel into the leg via the bearing mount.

Additionally, or alternatively, in some configurations optionally the arc gear can include a first piece of metal forming sidewalls and a second piece of sheet metal forming a gear tooth strip, the gear tooth strip interlocking with the sidewalls.

Additionally, or alternatively, in some configurations optionally the system is coupled to a first purlin supporting a first plurality of solar panels, and the rotation of the arc gear to the stow position locks the first plurality of solar panels in a fixed position.

Under another aspect, a system for rotatably mounting and locking a plurality of solar trackers can include a first mechanism coupled to a first solar tracker; and a second mechanism coupled to a second solar tracker. The first and second mechanisms each can include a drive mechanism and a locking mechanism. The drive mechanism can include a drive shaft, a pinion gear, and an arc gear. The pinion gear can be coupled to the drive shaft and can include pinion gear teeth. The arc gear can be coupled to the corresponding solar tracker and can include a first section, the first section can include arc gear teeth. The locking mechanism can include a lock plate and a drive pin. The drive pin can be coupled to the pinion gear. The lock plate can be coupled to the arc gear and can include a slot configured to engage the drive pin. The drive shaft of the first mechanism can be flexibly coupled to the drive shaft of the second mechanism. Responsive to rotation of the first drive shaft by a first amount, engagement of the pinion gear teeth of the first mechanism with the arc gear teeth in the first section of the first mechanism rotates the arc gear of the first mechanism; the second drive shaft rotates by the first amount via the flexible coupling; and engagement of the pinion gear teeth of the second mechanism with the arc gear teeth in the first section of the second mechanism rotates the arc gear of the second mechanism. Responsive to rotation of the first drive shaft by a second amount, the slot of the lock plate of the first mechanism engages with the drive pin of the first mechanism and the arc gear teeth of the first mechanism disengage from the pinion gear teeth of the first mechanism; the second drive shaft rotates by the second amount via the flexible coupling; and the slot of the lock plate of the second mechanism engages with the drive pin of the second mechanism and the arc gear teeth of the second mechanism disengage from the pinion gear teeth of the second mechanism.

In some configurations, optionally the pinion gear of each of the first and second mechanisms further can include a bearing surface and the lock plate of each of the first and second mechanisms further can include a reaction surface. Responsive to rotation of the first drive shaft by a third amount and the engagement between the slot of the lock plate of the first mechanism with the drive pin of the first mechanism, the arc gear of the first mechanism can rotate to a stow position at which the reaction surface of the first mechanism bears against the bearing surface of the first mechanism, the second drive shaft can rotate by the third amount via the flexible coupling, and the arc gear of the second mechanism can rotate to a stow position at which the reaction surface of the second mechanism bears against the bearing surface of the second mechanism.

Additionally, or alternatively, in some configurations optionally the arc gear of each of the first and second mechanisms further can include a second section lacking arc gear teeth, and the lock plate can be coupled adjacent to the second section.

Additionally, or alternatively, optionally the rotation of the arc gear of the first mechanism to the stow position occurs at a different time than the rotation of the arc gear of the second mechanism to the stow position.

Under another aspect, a method for rotatably mounting and locking a solar panel can include providing a drive mechanism, which can include a drive shaft, a pinion gear, and an arc gear. The pinion gear can be coupled to the drive shaft and can include pinion gear teeth and a bearing surface. The arc gear can be coupled to the solar panel and can include a first section, the first section can include arc gear teeth. The method also can include providing a locking mechanism can include a lock plate coupled to the arc gear and can include a reaction surface. The method also can include rotating the drive shaft by a first amount such that engagement of the pinion gear teeth with the arc gear teeth in the first section rotates the arc gear. The method also can include rotating the drive shaft by a second amount while engaging the slot of the lock plate with the drive pin such that the arc gear rotates to a stow position at which the reaction surface bears against the bearing surface and locks the arc gear in place.

In some configurations, optionally the locking mechanism further can include a drive pin coupled to the pinion gear; and the lock plate further can include a slot configured to engage the drive pin. The method can include rotating the drive shaft by a third amount such that the slot of the lock plate engages with the drive pin responsive to which the arc gear teeth disengage from the pinion gear teeth.

Additionally, or alternatively, in some configurations optionally the arc gear further can include a second section lacking arc gear teeth, and the lock plate can be coupled adjacent to the second section.

Additionally, or alternatively, in some configurations optionally the method further can include providing a leg and a bearing mount coupled to the leg, the bearing mount supporting the drive shaft and the pinion gear.

Additionally, or alternatively, in some configurations optionally the method further can include, when the arc gear is at the stow position, the bearing of the reaction surface against the bearing surface substantially transmitting a wind load on the solar panel into the leg via the bearing mount.

Additionally, or alternatively, in some configurations optionally the arc gear can include a first piece of metal forming sidewalls and a second piece of metal forming a gear tooth strip, the gear tooth strip interlocking with the sidewalls.

Additionally, or alternatively, in some configurations optionally the mechanism is coupled to a first purlin supporting a first plurality of solar panels, the rotation of the arc gear to the stow position locking the first plurality of solar panels in a fixed position.

Under still another aspect, a method for rotatably mounting and locking a plurality of solar trackers can include providing a first mechanism coupled to a first solar tracker; and providing a second mechanism coupled to a second solar tracker. The first and second mechanisms each can include a drive mechanism and a locking mechanism. The drive mechanism can include a drive shaft, a pinion gear, and an arc gear. The pinion gear can be coupled to the drive shaft and can include pinion gear teeth. The arc gear can be coupled to the corresponding solar tracker and can include a first section, the first section can include arc gear teeth. The locking mechanism can include a lock plate and a drive pin. The drive pin can be coupled to the pinion gear, and the lock plate can be coupled to the arc gear and can include a slot configured to engage the drive pin. The drive shaft of the first mechanism can be flexibly coupled to the drive shaft of the second mechanism. The method can include rotating the first drive shaft by a first amount such that engagement of the pinion gear teeth of the first mechanism with the arc gear teeth in the first section of the first mechanism rotates the arc gear of the first mechanism. The method can include rotating the second drive shaft by the first amount via the flexible coupling such that engagement of the pinion gear teeth of the second mechanism with the arc gear teeth in the first section of the second mechanism rotates the arc gear of the second mechanism. The method can include rotating the first drive shaft by a second amount such that the slot of the lock plate of the first mechanism engages with the drive pin of the first mechanism and the arc gear teeth of the first mechanism disengages from the pinion gear teeth of the first mechanism. The method can include rotating the second drive shaft by the second amount via the flexible coupling such that the slot of the lock plate of the second mechanism engages with the drive pin of the second mechanism and the arc gear teeth of the second mechanism disengage from the pinion gear teeth of the second mechanism.

In some configurations, optionally the pinion gear of each of the first and second mechanisms further can include a bearing surface, and the lock plate of each of the first and second mechanisms further can include a reaction surface. The method further can include rotating the first drive shaft by a third amount while engaging the slot of the lock plate of the first mechanism with the drive pin of the first mechanism such that the arc gear of the first mechanism rotates to a stow position at which the reaction surface of the first mechanism bears against the bearing surface of the first mechanism. The method also can include rotating the second drive shaft by the third amount via the flexible coupling such that the arc gear of the second mechanism rotates to a stow position at which the reaction surface of the second mechanism bears against the bearing surface of the second mechanism.

Additionally, or alternatively, in some configurations optionally the arc gear of each of the first and second mechanisms further can include a second section lacking arc gear teeth, and the lock plate can be coupled adjacent to the second section.

Additionally, or alternatively, optionally the rotation of the arc gear of the first mechanism to the stow position occurs at a different time than the rotation of the arc gear of the second mechanism to the stow position.

Under yet another aspect, a method of assembling a solar tracker can include forming a concrete track; and establishing a staging area at one end of the concrete track. The method also can include building a tracker structure on a cart at the staging area; and moving the cart along the concrete track to a location where the tracker structure is to be installed. The method also can include removing the tracker structure from the cart and placing the tracking structure on the concrete track; and connecting a coupling of the tracker structure to a coupling of an adjacent tracker structure. The method also can include securing the tracker structure in place on the concrete track; and fastening one or more solar panels to the tracker structure.

In some configurations, optionally, securing the tracker structure in place on the concrete track can include applying adhesive to feet of the tracking structure.

### BRIEF DESCRIPTION OF DRAWINGS

FIG. 1 schematically illustrates a perspective view of an exemplary configuration of a solar tracker.

FIGS. 2A and 2B schematically illustrate perspective views of certain components of the exemplary solar tracker illustrated in FIG. 1.

FIG. 3 schematically illustrates another view of the solar tracker of FIG. 1, with certain elements omitted for clarity.

FIG. 4 schematically illustrates a perspective view of an alternative exemplary configuration of a solar tracker.

FIG. 5 schematically illustrates a detailed view of an exemplary configuration of certain components of the exemplary solar tracker illustrated in FIG. 4.

FIG. 6 schematically illustrates a detailed view of an exemplary configuration of a component of the exemplary solar tracker illustrated in FIG. 4.

FIGS. 7A-7C respectively schematically illustrate detailed views of an exemplary configuration of a locking mechanism in three different exemplary solar tracker positions.

FIG. 8 illustrates a flow of steps in an exemplary method to rotate a solar tracker, for example, to track the sun from East to West or to return it to its starting position at the end of the day.

FIG. 9 illustrates a flow of steps in an exemplary method to position a solar tracker in a stow position.

FIG. 10A schematically illustrates an exemplary configuration of an arc gear.

FIG. 10B schematically illustrates another exemplary configuration of an arc gear.

FIG. 11 schematically illustrates an alternative exemplary configuration of solar tracker locking mechanisms such as illustrated in FIGS. 2 through 6.

FIG. 12 schematically illustrates an exemplary configuration of a slide-lock mechanism.

FIG. 13 schematically illustrates a perspective view of an alternative locking mechanism exemplary configuration.

FIG. 14 schematically illustrates a perspective view of another alternative exemplary configuration of a solar tracker locking mechanism.

FIG. 15 schematically illustrates a perspective view of another exemplary configuration of a solar tracker locking mechanism.

FIG. 16 schematically illustrates a perspective view of yet another exemplary configuration of a solar tracker locking mechanism.

FIG. 17 schematically illustrates an exemplary configuration including multiple sections of solar trackers coupled together.

FIG. 18 schematically illustrates an exemplary coupling joint compatible, for example, with the configuration illustrated in FIG. 17.

FIG. 19 schematically illustrates a cross-sectional view of the exemplary coupling joint illustrated in FIG. 18.

FIG. 20 schematically illustrates an exemplary cart for transporting a tracker frame along a length of a track.

FIGS. 21A and 21B schematically illustrate perspective views of an alternative exemplary configuration of a solar tracker.

FIG. 22 schematically illustrates a perspective view of an exemplary configuration of a solar tracker locking mechanism in a stow position.

FIG. 23A schematically illustrates a perspective view of an alternative exemplary configuration of a solar tracker.

FIG. 23B schematically illustrates a plan view of an exemplary solar panel assembly compatible with the solar tracker of FIG. 23A.

FIG. 24 schematically illustrates certain components during an exemplary method for assembling a solar tracker.

FIG. 25 schematically illustrates a flow of steps in an exemplary method for assembling a solar tracker.

FIGS. 26A-26B schematically illustrate plan views of exemplary layouts of solar trackers.

FIGS. 27A-27D schematically illustrate other exemplary configurations of cart-based assembly.

FIGS. 28A-28C schematically illustrate other exemplary configurations of arc gears.

FIG. 29 schematically illustrates a pinion gear with a tapered shape that can move gears back into alignment in a manner such as shown in FIG. 29.

### DETAILED DESCRIPTION

Systems and methods are provided for rotatably mounting and locking solar panels, such as photovoltaic panels. For example, the solar panels can be mounted so as to be rotatable about an axis so as to track the sun over the course of the day, and can be locked in a suitable position during high-wind conditions.

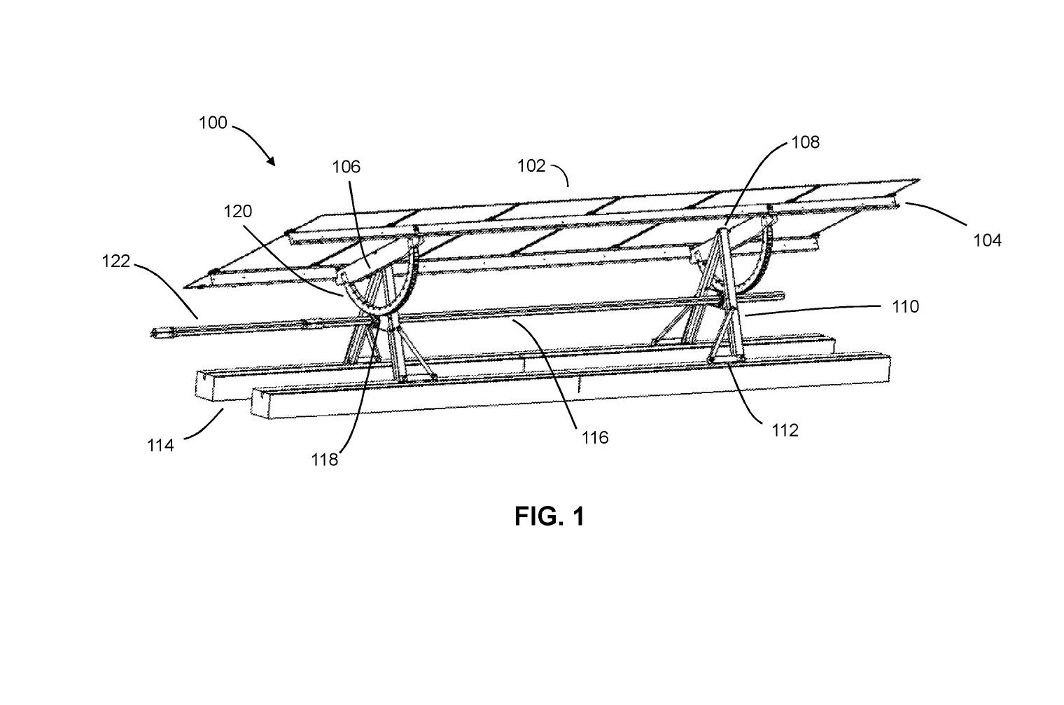

FIG. 1 schematically illustrates a perspective view of an exemplary configuration of a solar tracker 100. A plurality of such solar trackers 100 can be connected end to end so as to provide a larger solar collector system. In exemplary solar tracker 100 illustrated in FIG. 1, a row of solar panels, e.g., photovoltaic panels 102, mounted on two purlins 104. In this example, there are six solar panels 102 and two purlins 104 illustrated, but it should appreciate that solar tracker 100 suitably can include more or fewer solar panels 102, and more or fewer purlins 104, than are illustrated. The purlins 104 can be mounted on any suitable number of pivot arms 106, e.g., two pivot arms 106 such as illustrated in FIG. 1. At the midpoint or approximately the midpoint of each pivot arm 106, a hole can be provided that forms a bearing having an axis of rotation aligned with the row of panels. Each of these bearings can be mounted on a respective axle 108, which can be at the top of a set of legs 110 that acts as a support structure. Such a bearing-axle assembly can allow the pivot arms 106, and therefore the solar panels 102 attached to purlins 104 which are attached to the pivot arms 106, to rotate about an axis aligned with the row of panels.

In the nonlimiting configuration illustrated in FIG. 1, each set of legs 110 includes two feet 112. In the configuration of FIG. 1, feet 112 are mounted on concrete tracks 114 and secured thereto by adhesive. The concrete tracks 114 incorporate a mounting surface and act as a ballast foundation for the overall structure. Tracks can also act as a guide for vehicles such as solar panel maintenance and diagnostic machines. Note that the solar tracker feet 112 can stand on a single slip-formed concrete ballast or on two separate slip-formed concrete ballasts, as in FIG. 1. Each foot 112 could alternatively stand on individual concrete blocks that could be precast or poured in place. Each set of two feet 112 of a set of legs 110 could alternatively use a common concrete foundation. Alternatively, each foot 112 or each set of feet of a set of legs 110 could use one or more elements that protrude into the ground as a foundation, such as stakes, ground nails, ground screws, or pile foundations.

The rotation of the solar panels 102 can be powered by a motor, which is not specifically illustrated in FIG. 1. Illustratively, the motor can drive a drive shaft 116. A pinion gear 118 can transfer rotational power and torque from the drive shaft 116 to arc gears 120. The legs, pivot arms, and arc-gear together optionally provide an A-frame assembly. Although the nonlimiting configuration illustrated in FIG. 1 includes two A-frame assemblies, it should be appreciated that there could be more than two A-frame assemblies per solar tracker. The arc gears 120 respectively can be connected to the pivot arms 106 and rotate the pivot arms about their respective axles 108. In this way the solar panels 102 can be rotatably coupled to the drive shaft 116 (and thus the motor). Optionally, a coupling 122 can be coupled to the drive shaft 116 and to the drive shaft of another solar tracker 100, e.g., so as to connect solar tracker sections together such that rotation of the drive shaft of a first solar tracker drives the rotation of the drive shaft of a second solar tracker via coupling 122. Any suitable number of solar trackers can be coupled to one another via such couplings 122. In configurations provided herein, drive shafts suitably can be hollow or solid.

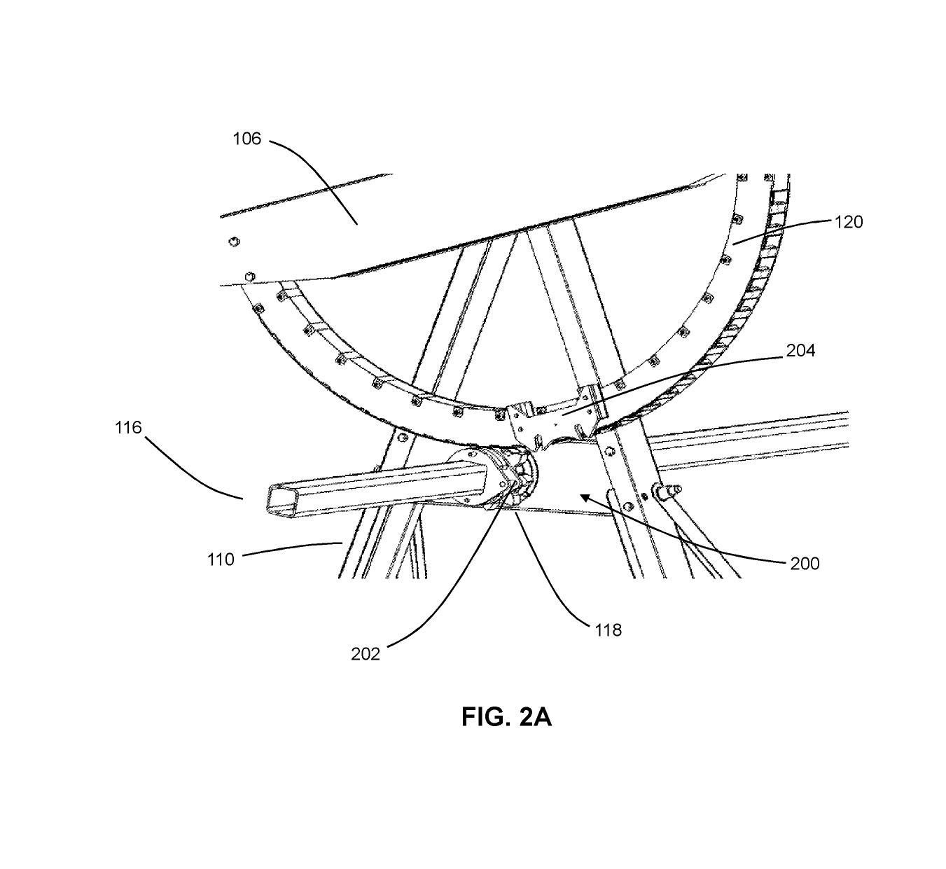

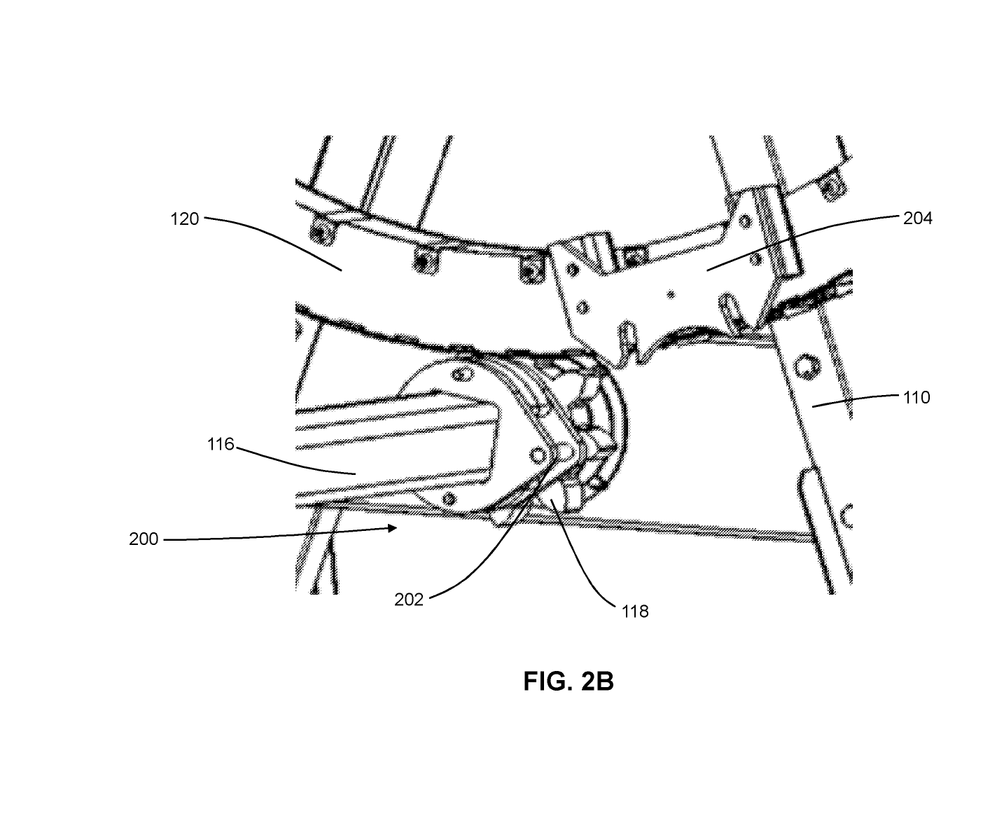

FIGS. 2A and 2B schematically illustrate detailed, perspective views of certain components of the exemplary solar tracker illustrated in FIG. 1. For example, FIGS. 2A and 2B schematically illustrate detailed, perspective views of the arc gear 120 and pinion gear 118 of the exemplary solar tracker 100 illustrated in FIG. 1. FIG. 2B is a zoomed-in view of FIG. 2A. In the nonlimiting configuration illustrated in FIGS. 2A-2B, the pinion gear 118 can include a series of teeth that intermesh with the teeth of the arc gear 120. In addition, a drive pin 202 can be mounted to and rotatably coupled to the pinion gear 118, and a lock plate 204 can be mounted to and rotatably coupled to the arc gear 120. The pinion gear 118 and lock plate 204 together can provide a locking mechanism 200 such as described in greater detail herein.

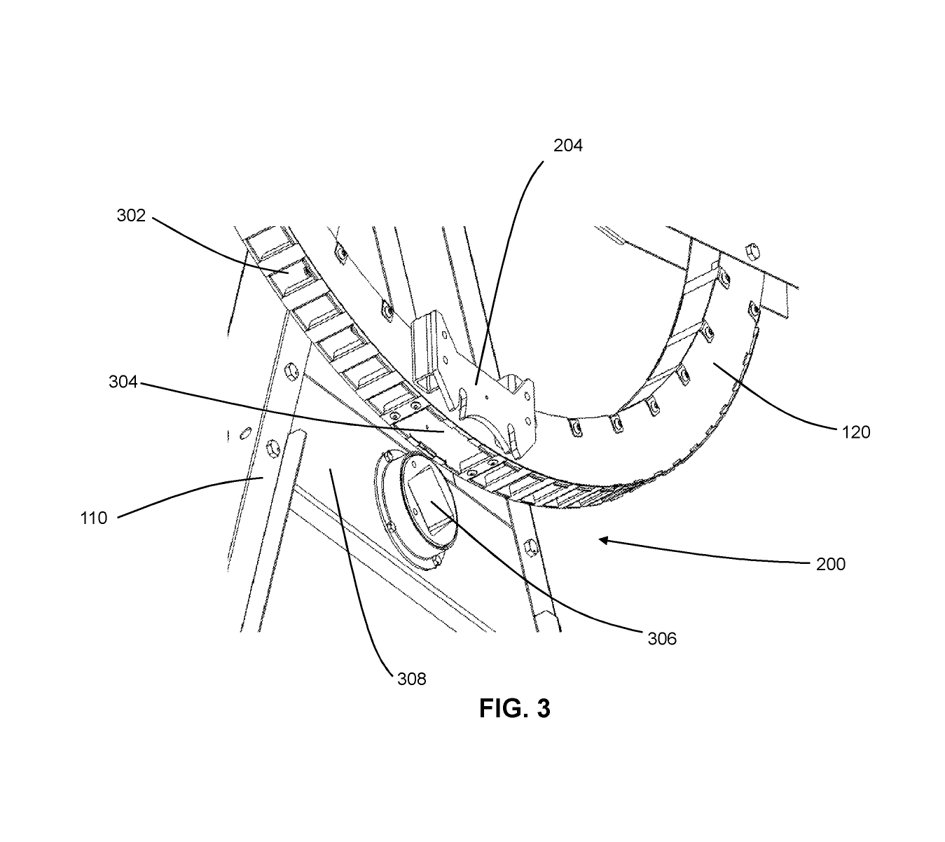

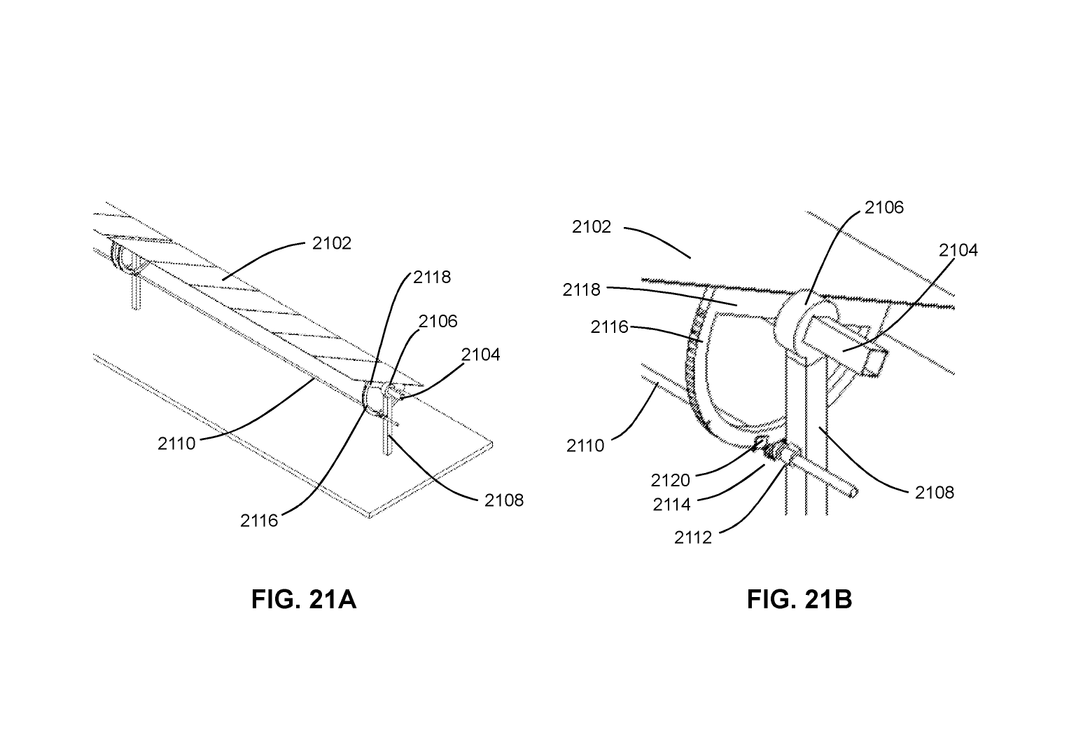

FIG. 3 schematically illustrates another view of the solar tracker of FIG. 1, with certain elements omitted for clarity. For example, FIG. 3 schematically illustrates another view of the solar tracker 100 of FIG. 1, but with the drive shaft 116, pinion gear 118, and drive pin 202 omitted for clarity. FIG. 3 schematically illustrates that the teeth 302 of the arc gear 120 need not necessarily continue around the entire arc of the arc gear 120. For example, the arc gear 120 can include a gap 304 between the teeth 302 at the location of the lock plate 204. Within gap 304, the teeth of the pinion gear 118, illustrated in FIG. 2, do not engage with the teeth 302 of the arc gear 120 such that the drive shaft 116 can rotate without rotating the arc gear 120 and therefore without rotating the solar panels 102. As such, when many trackers are connected end to end (e.g., via coupling 122), such trackers can all be brought into alignment with one another even though rotational offsets can exist in the system, e.g., from coupling 122 gaps and drive shaft 116 twist. FIG. 3 also schematically illustrates that the drive shaft 116 can be supported by a bearing mount 306 that can be mounted in a tie 308, which is supported by and adds stiffness to the support legs 110. Alternatively, in a manner such as described below with reference to FIGS. 21A-21B, a bearing mount can be coupled to a leg in such a manner as to support the drive shaft and pinion gear.

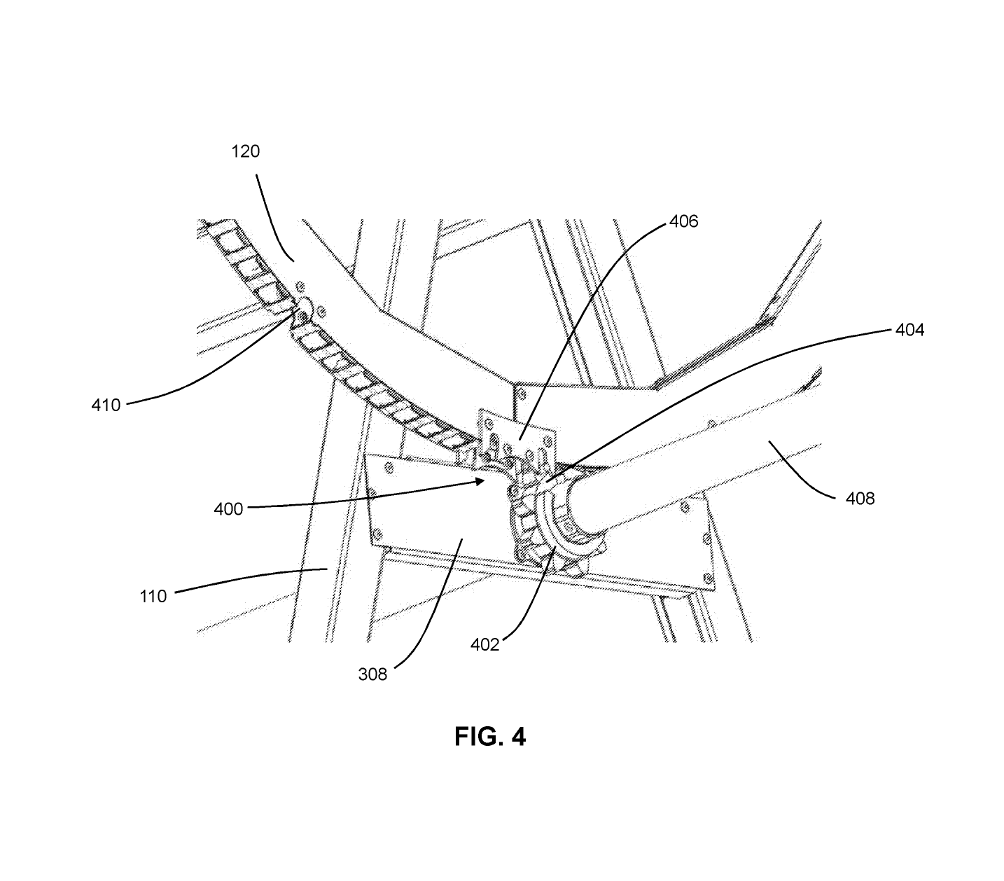

FIG. 4 schematically illustrates a perspective view of an alternative exemplary configuration of a solar tracker. The exemplary configuration of FIG. 4 can include the same arc gear 120 as in the exemplary configuration in FIG. 1, and it also includes a locking mechanism 400. A drive pin 404 can be integrated into the pinion gear 402, and can continue from one side of the pinion gear to the other. Similarly as in FIGS. 2A and 2B, a lock plate 406 can be mounted on the arc gear 120. However, in the exemplary configuration of FIG. 4, the lock plate 406 can include two plates mounted on either side of the arc gear 120. Both parts of the lock plate 406 can be driven by the drive pin 404. A drive shaft 408 can connect a motor, not specifically illustrated, to the pinion gear 402 and the drive pin 404. The drive shaft's 408 cross section is cylindrical in the example illustrated in FIG. 4, but suitably could be rectangular or another shape of cross section. In the nonlimiting configuration of FIG. 4, the arc gear 120 can include cut-outs 410 at appropriate locations so as to avoid interference between the drive pin 404 and the arc gear 120.

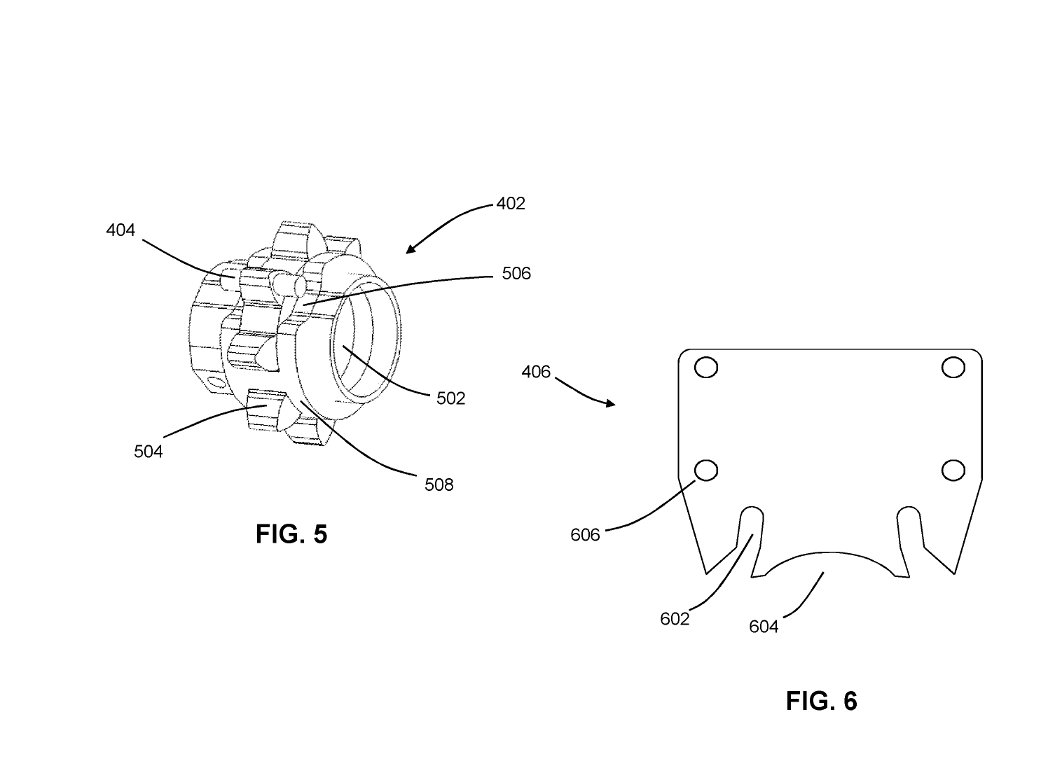

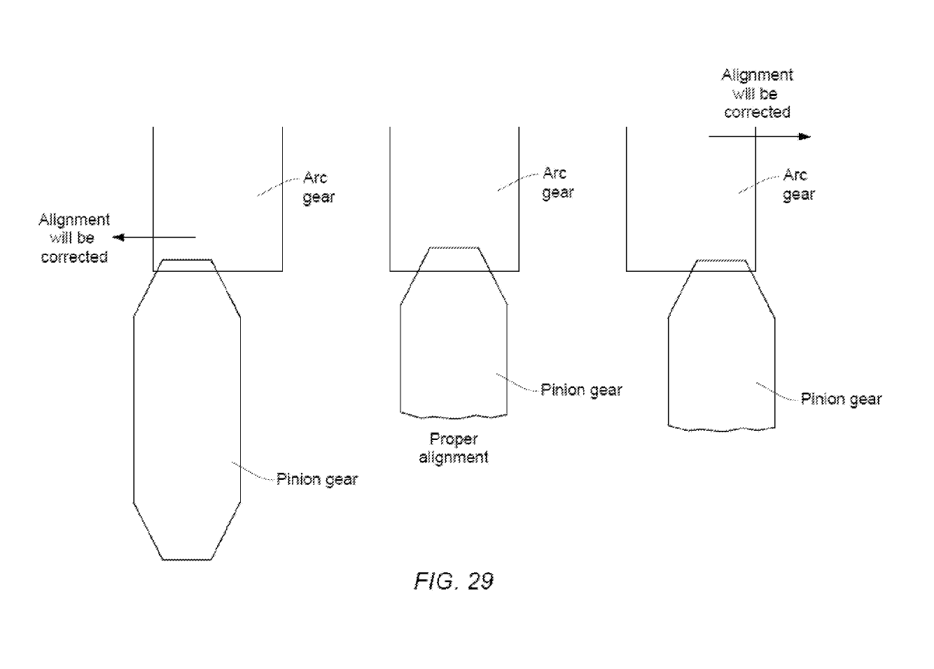

FIG. 5 schematically illustrates a detailed view of an exemplary configuration of certain components of the exemplary solar tracker illustrated in FIG. 4. For example, FIG. 5 schematically illustrates a detailed view of an exemplary configuration of the pinion gear 402 and drive pin 404. Pinion gear 402 can include a through-hole 502 along its axis and configured to accept and engage with the drive shaft 116, which is illustrated in FIGS. 1 and 2. Pinion gear 402 also can include pinion gear teeth 504, a round bearing surface 508 that corresponds to the shape of the curved surface on the lock plate 406, and recesses 506 configured so as to allow protrusions on the lock plate 406 to move around the drive pin 404 without interference. In some embodiments, pinion gear 402 can be tapered. For example, at a tapered section of pinion gear 402, the base of each tooth 504 can be wider than the tip of that tooth. According to some embodiments, a tapered pinion gear can reduce or minimize the possibility of binding or separation between the pinion gear and arc gear. For example, if the gears are misaligned, the tapered shape of the pinion gear and the motion of the gears can move them back into alignment in a manner such as shown in FIG. 29.

FIG. 6 schematically illustrates a detailed view of an exemplary configuration of a component of the exemplary solar tracker illustrated in FIG. 4. For example, FIG. 6 schematically illustrates a detailed view of an exemplary configuration of the lock plate 406. The lock plate 406 includes any suitable number of pin slots 602, e.g., two pin slots 602 in the illustrated configuration, and a reaction surface 604 that is in the shape of an arc of a circle, which matches the curvature of the bearing surface 508 on the pinion gear 402 such as illustrated in FIG. 5. The pin slots 602 are configured so as to accept the drive pin 404, to advance the arc gear 120 to the stow position, and to permit additional drive shaft 408 rotation without rotation of the solar panels 102. The reaction surface 604 is configured so as to lock rotation of the arc gear 120 by bearing against the pinion bearing surface 508. The lock gear 406 also includes a series of mounting holes 606, e.g., four mounting holes 606, configured so as to mount the lock gear to the arc gear 120 via respective mechanical fasteners.

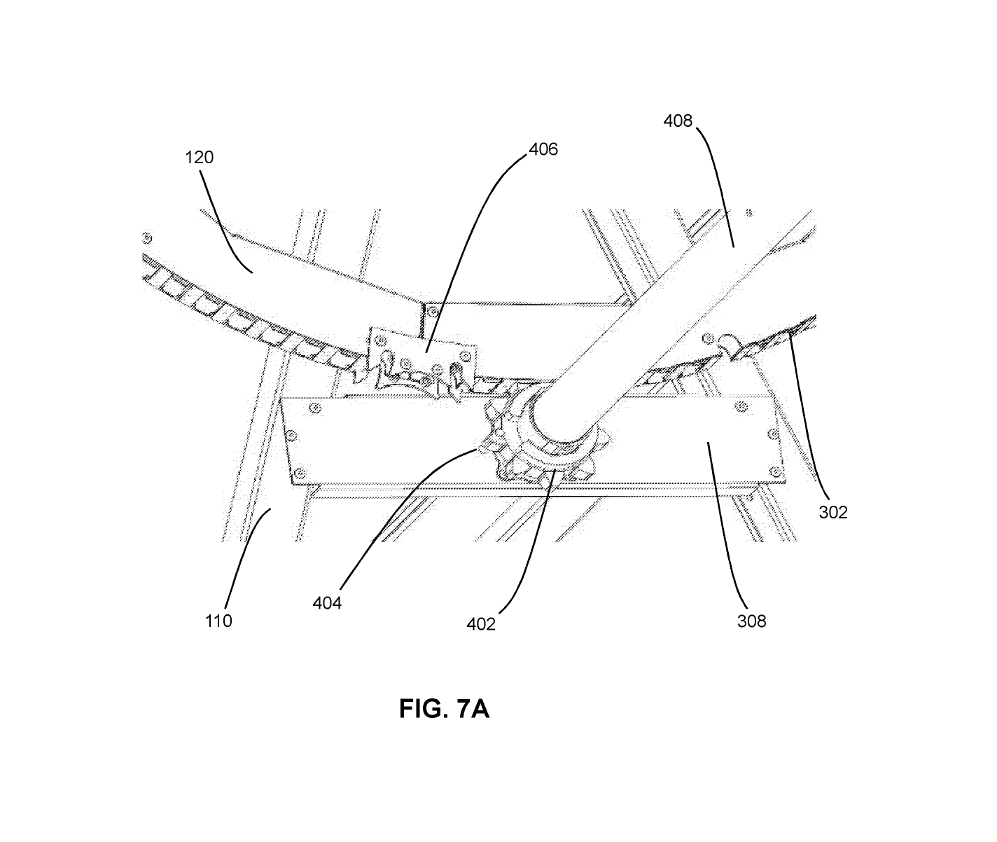

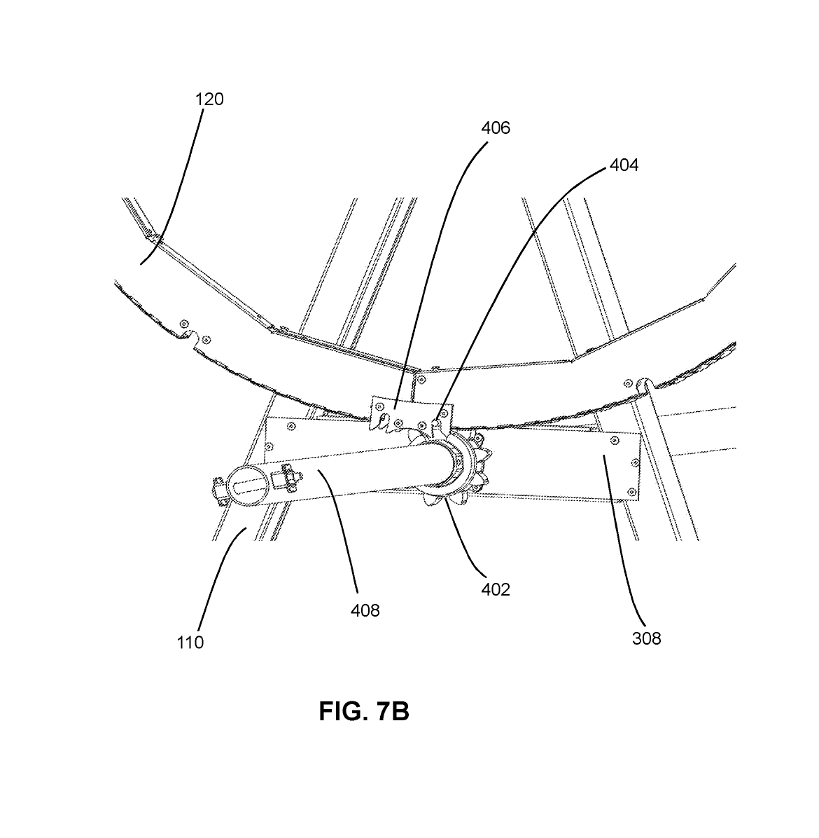

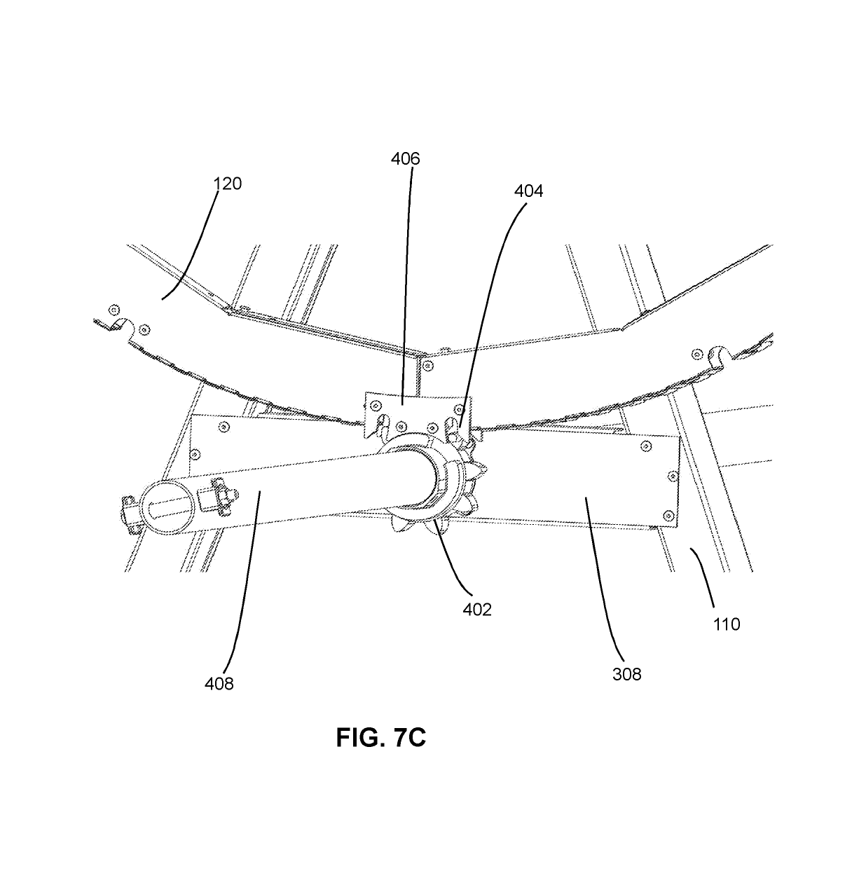

FIGS. 7A-7C respectively schematically illustrate detailed views of an exemplary configuration of the locking mechanism in three different exemplary solar tracker positions, for example representing how the tracker can rotate to track the sun. In the position illustrated in FIG. 7A, the pinion gear 402 is engaged with the arc gear teeth 302, and the lock plate 406 is not engaged with the drive pin 404, permitting arc gear 120 to rotate based on rotation of drive shaft 408. As the tracker changes from the position illustrated in FIG. 7A to the position illustrated in 7B based on further rotation of drive shaft 408, the pinion gear 402 rotates further, causing the arc gear 120 to rotate thereby moving along the arc of the arc gear 120. Each lock plate 406 includes drive pin slots 602, e.g., two drive pin slots 602, and the drive pin 404 is configured so as to fit inside each slot. FIG. 7B schematically illustrates a position in which the drive pin 404 is engaged in a slot 602 of the lock plate 406, and the teeth 118 of the pinion gear 402 are no longer engaged with teeth 302 of the arc gear 120 because the gap 304 in the arc gear's teeth is aligned with the lock plate in a manner such as illustrated in FIG. 3. The interaction and engagement of the drive pin 404 and the slot 602 in the lock plate 406 can cause the arc gear 120 to be rotated by the rotating pinion gear 402. Similarly, with the drive pin 404 engaged in the slot 602, the pinion gear 402 resists torque applied to it by the arc gear 120, e.g., by wind forces. Further rotating the pinion gear 402 via rotation of drive shaft 408 can advance the system to the position illustrated in FIG. 7C in which the drive pin 404 is no longer engaged with the lock plate 406. The pinion gear 402 and drive shaft 408 can now rotate without rotating the arc gear 120, and this can be referred to as the dwell phase or the wind stow position. In this phase or position, the arc gear 120 cannot rotate because of the engagement and radial fit between the curved section 604 of the lock plate 406 and the cylindrical shoulder section 508 of the pinion gear 402. For example, if a torque were applied (e.g., by wind forces on the solar panels 102) to the pivot arm 106 in the position illustrated in FIG. 7C, i.e., in stow mode, this torque can result in a force directed radially inward to the pinion gear 402 and therefore into the drive shaft 408, tie 308, tracker legs 110, and the track 114. However, in the position illustrated in FIG. 7A or 7B, torque applied (e.g., by wind to the solar panels 102) to the pivot arm 106 can be transferred as a torque to the drive shaft 116, coupling 122, and drive motor (not specifically illustrated). Continuing with FIG. 7C, in this position, the solar tracker 100 is locked in place, and wind loads on the panels substantially are transmitted into the frame and base of the tracker rather than into the drive shaft and motor. To continue tracking, the drive shaft 408 can rotate the pinion gear 402 and drive pin 404 again to the position illustrated in FIG. 7B at which the pin 402 is engaged with the one of the slots of the lock plate 406. In this position, rotation of the drive pin 404 causes the arc gear 120 to rotate until the teeth of the pinion gear 402 engage with the teeth of the arc gear 302.

One consideration for the design of a solar tracker is wind loading. For example, in some configurations the wind can impart a force on the solar panels, which in turn can impart a torque on the drive shaft, which can undesirably transmit torque to the motor. In such a configuration, the motor and drive shaft system can be configured so as to resist torques resulting from wind loading on all of the tracker sections to which the motor and the drive shaft system are connected. The design wind load is specified to be the highest wind speed the system could conceivably face, which wind speed can be expected to occur only rarely. For example, perhaps once a year a site may be subject to wind speeds of 50 miles/hour, and the design point for the site might be 100 miles/hour which may occur once every two centuries. By contrast, the wind speed might stay below 10 miles per hour for the large majority of the operating hours of the solar plant.

One exemplary approach to address such a situation is to configure the tracker to operate normally up to a cutoff wind speed, say 40 miles/hour, and to be positioned in a “stow position” based upon wind speeds exceeding the cutoff. By configuring the tracker with such different modes, phases, or positions, the motor and drive shaft system suitably can have a significantly lower torque rating than for the case where the motor instead must be configured so as to withstand the higher, design-point wind speed. Such a lower torque rating can save considerable cost. In a stow position, the tracker could better endure high wind speeds.

In addition, a gear reduction provided by the arc gear, integrated with the locking mechanism, can relieve demand on the motor, drive shaft, and locking mechanism.

Useful features of integrated locking mechanisms 200 and 400 such as illustrated in FIGS. 2A-7 include one or more of the following: the tracker sections are configured so as to be rotatable to a stow position, wind forces can be transferred through the tracker structure and base instead of as torque through the drive shaft, and/or torque demand in operation can be reduced.

An exemplary configuration for driving solar trackers includes one motor to drive a plurality of tracker sections with torque and power transmitted via a drive shaft 116 connected via couplings 122, e.g., as described above with reference to FIG. 1. Angular deviation can exist between the motor shaft angle and the pinion gear 118 angle of a tracker section coupled to the motor as a result of coupling tolerances and twist. One or a number of tracker sections can be coupled to the first tracker section, and angular deviation of the pinion gears can increase with increasing number of mechanical connections in the drive shaft down the line of tracker sections. All of the tracker sections can be rotated to the stow position. In some configurations, rotating all of the tracker sections to the stow position can include each section being substantially at the same, predetermined angle as one another.

In some configurations, the locking mechanism, e.g., 200 in FIGS. 2 and 400 in FIG. 4, can correct for angular deviation and can provide that all of the tracker sections coupled to a motor are substantially at the same angle as one another for stow position and that the locking mechanisms are engaged in all of the sections in the stow position. In one nonlimiting example, the tracker section illustrated in FIG. 7A-7C is the first section directly coupled to the drive motor, and is angled eastward and is rotating from east to west going from FIG. 7A to 7B to 7C. The next tracker section coupled to the first section on the end opposite of the motor can be angled slightly more toward the horizon and lagging relative to the first section, for example because of angular deviation, as both sections rotate from east to west. Additional tracker sections can lag behind the first and second tracker sections as the incremental angular deviation adds together one section at a time. On the first tracker section, the drive pin 404 engages the lock plate 406, as in FIG. 6B, and then disengages it, as in FIG. 7C, and then the pinion gear 402 begins to rotate without rotating the arc gear 120. The first tracker section is now in stow position, and the arc gear 120 dwells at this angle while the drive shaft 408 continues rotating. Because other coupled tracker sections that are further from the motor can lag the first section in rotation, such sections may not necessarily have entered stow position yet. As the drive shaft 408 continues to rotate, the first tracker section dwells in stow position while the coupled tracker sections enter stow position, e.g., one-by-one. The motor can be stopped after all of the trackers have reached the stow position. In such a manner, all of the coupled tracker sections become aligned substantially at the correct, stow-position angle with each of their locking mechanisms engaged in spite of any deviation error in the drive shaft from coupler tolerances and drive shaft twist.

Additionally, or alternatively, when the tracker is in stow-position, the locking mechanism, e.g., 200 in FIG. 2 and 400 in FIG. 4, can be configured so as to inhibit or prevent the transfer of torque from the arc gear 120 to the drive shaft 116, illustrated in FIG. 1, and instead to transfer wind forces from the arc gear radially inward toward the center of drive shaft at the location of the locking plates. For example, as described above with reference to FIG. 7C, the curved section of the lock plate 406 can be configured so as to closely fit around the shoulder 508 of the pinion gear 402 while the drive pin 404 and the gear teeth 504 are both disengaged. In such a position, any torque applied to the pivot arm 306 from wind can cause the lock plate 406 to bear on the shoulder 508 of the pinion gear 402. The bearing forces then can be transferred radially through the drive shaft bearing 306 in FIG. 3 and into the leg structure 110 and concrete base 114 in FIG. 1. When the locking mechanism is not engaged (e.g., such as described above with reference to FIG. 7A), wind forces on all of the tracker sections can apply a torque, reduced by the arc gear, to the drive shaft and motor. When the locking mechanism is engaged (e.g., such as described above with reference to FIG. 7C), wind loading on each tracker section can be transferred into the mounting structures of those individual sections, thereby reducing or eliminating stress and twist in the system from high wind loads.

In some circumstances, wind can excite oscillating vibrations in a solar tracker. In configurations such as provided herein, e.g., with reference to FIGS. 1-7C, intermeshing of the gear teeth of the arc gear with the arc teeth of the pinion gear can dampen such oscillating vibrations. Additionally, the materials of one or both of the arc gear and the pinion gear suitably can be selected so as to enhance such dampening, e.g., by suitably increasing friction between the arc gear and the pinion gear.

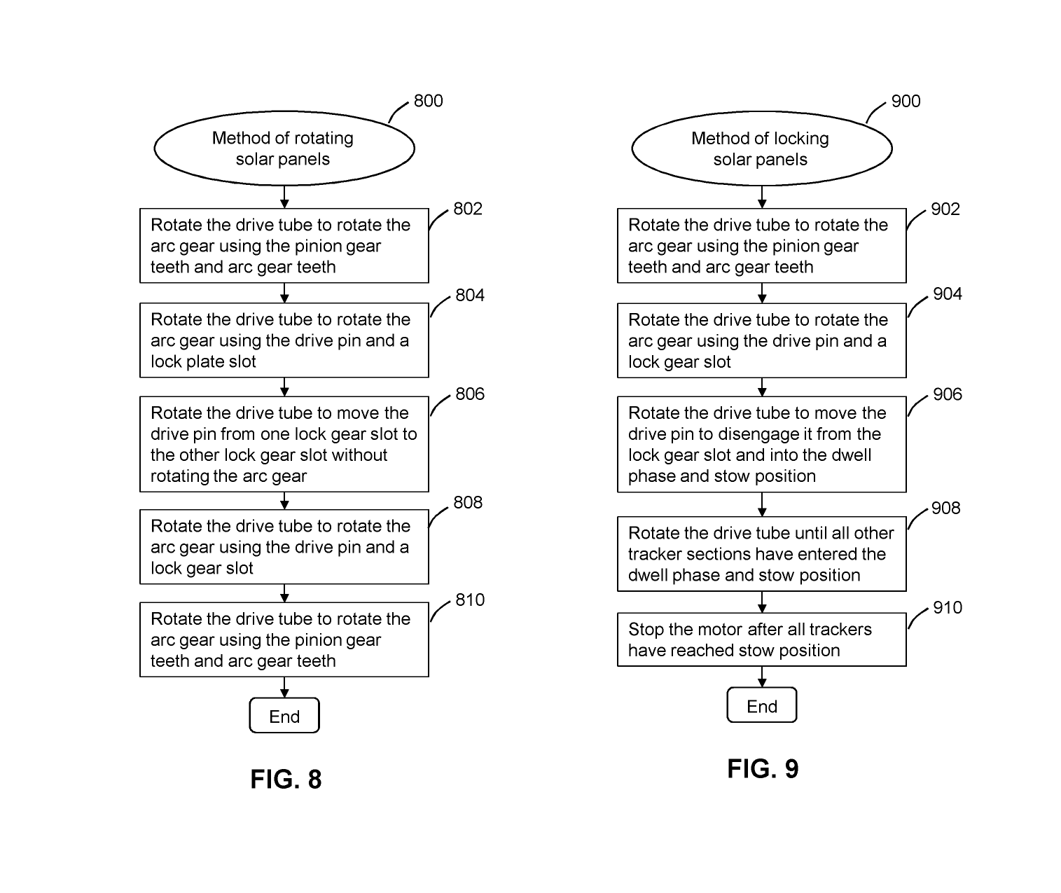

FIG. 8 illustrates a flow of steps in an exemplary method to rotate a solar tracker, for example, to track the sun from East to West or to return it to its starting position at the end of the day. Method 800 includes rotating the drive shaft to rotate the arc gear using the pinion gear teeth and arc gear teeth (802), e.g., in a manner such as described herein with reference to FIG. 7A. Method 800 also includes rotating the drive shaft to rotate the arc gear using the drive pin and a lock plate slot (804), e.g., in a manner such as described herein with reference to FIG. 7B. Method 800 also includes rotating the drive shaft to move the drive pin from one lock gear slot to the other lock gear slot without rotating the arc gear (806), e.g., in a manner such as described herein with reference to FIG. 7C. Method 800 also includes rotating the drive shaft to rotate the arc gear using the drive pin and a lock gear slot (808), e.g., in a manner such as described herein with reference to FIG. 7B. Method 800 also includes rotating the drive shaft to rotate the arc gear using the pinion gear teeth and arc gear teeth (810), e.g., in a manner such as described herein with reference to FIG. 7A.

FIG. 9 illustrates a flow of steps in an exemplary method to position a solar tracker in a stow position. Method 900 includes rotating the drive shaft to rotate the arc gear using the pinion gear teeth and arc gear teeth (902), e.g., in a manner such as described herein with reference to FIG. 7A. Method 900 also includes rotating the drive shaft to rotate the arc gear using the drive pin and a lock gear slot (904), e.g., in a manner such as described herein with reference to FIG. 7B. Method 900 also includes rotating the drive shaft to move the drive pin to disengage the drive pin from the lock gear slot and into the dwell phase (906), e.g., in a manner such as described herein with reference to FIG. 7C. Method 900 also includes rotating the drive shaft until all other tracker sections have entered the dwell phase and stow position (908), e.g., in a manner such as described elsewhere herein. Method 900 also includes stopping the motor after all of the trackers have reached the stow position (910), e.g., in a manner such as described elsewhere herein.

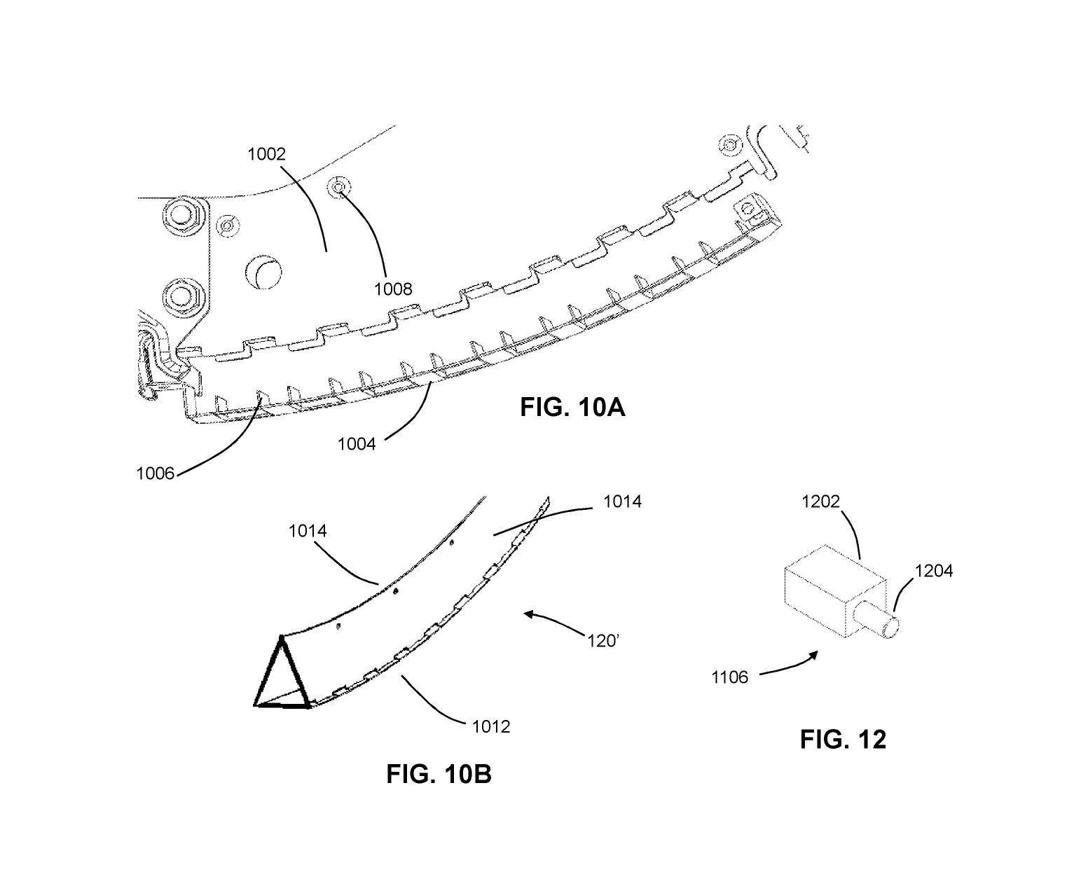

An arc tracker arc gear can be made up of, or include, sidewall pieces and one or more tooth strip pieces according to some embodiments. The sidewalls can be fastened to one another with rivets. FIG. 10A schematically illustrates a first exemplary configuration of an arc gear 120. In the configuration illustrated in FIG. 10A, the arc gear 120 can include or can be made of a structural piece 1002, which can be or include metal formed into a box cross section (e.g., defining sidewalls), and a bearing surface piece 1004 which can be or include metal, such as sheet metal, and which is configured so as to form the teeth 302 of the arc gear 120 (e.g., defining a gear tooth strip). The metal forming structural piece 1002 and/or the bearing surface piece 1004 each independently can include, or consist essentially of, for example, folded sheet metal, roll-formed metal, cast metal, plastic (such as injection-molded plastic), or other suitable material or combination of materials. In some configurations, the structural piece 1002 can be folded such that that an end-on cross section of the arc gear 120 is configured as a closed rectangle, and fasteners (such as rivets 1008) can be used across the top of the rectangle so as to increase rigidity. In certain configurations, by making structural piece 1002 and/or bearing surface piece 1004 out of a folded sheet, such as a folded sheet of metal, the cost and weight can be significantly reduced as compared with a gear made from a solid piece.

Continuing with the exemplary configuration illustrated in FIG. 10A, the bearing surface piece 1004 can be configured so as to include tabs 1006 that can be inserted inside the teeth openings in the structural piece 1002. For example, inward folded tabs 1006 can provide a relatively smooth bearing surface against which the teeth of the pinion gear 118 can press and slide. A useful feature of using a second bearing piece for the bearing surface is cost savings. A moderately costly material with good wear properties can be used for the bearing surface in limited quantity, while a cheaper material can be used more extensively for structural rigidity of the arc gear 120. A nonlimiting example includes using stainless steel for the bearing surface piece 1004 and galvanized steel for the structural piece 1002. Tabs that are formed off the arc gear sidewalls (corresponding to structural piece 1002) can be used to support the arc gear teeth (corresponding to bearing surface piece 1004). Such an arrangement can allow for relatively easy assembly. For example, the gear teeth piece can attach to the sidewalls as it gets stretched around the arc gear.

FIG. 10B schematically illustrates another exemplary configuration of an arc gear, e.g., such as can be used in a solar tracker mechanism provided herein. In the nonlimiting configuration illustrated in FIG. 10B, arc gear 1014 is shaped with a triangular cross section. The bottom of the arc gear 1014 includes gear teeth 1012, and the side walls 1014 can increase structural strength of the arc gear.

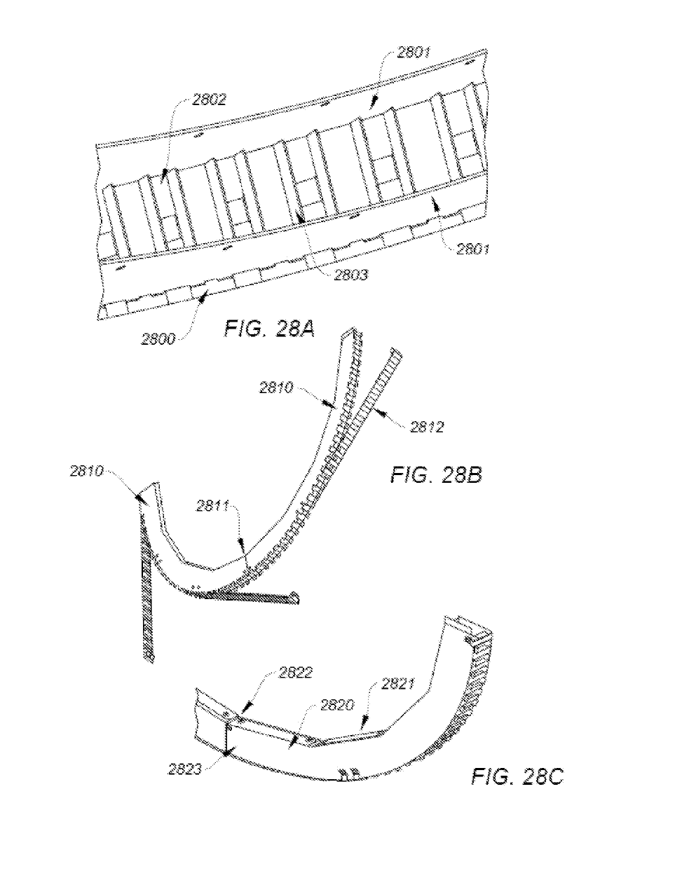

FIGS. 28A-28C schematically illustrate other exemplary configurations of arc gears. For example, FIG. 28A shows exemplary sidewall tabs that support the gear teeth strip according to some embodiments, e.g., a gear tooth strip 2800 configured similarly as bearing surface piece 1004 described above with reference to FIG. 10A. The strip includes first and second sidewalls 2801, a sidewall bent tab 2802 providing structural strength, and a gear tooth strip bent tab 2803 providing structural strength. For example, the interlocking features give the assembly strength. FIG. 28B shows an exemplary embodiment of a four-part arc gear that includes two side wall half-arc sections 2810, a seam 2811 between the side wall sections, and gear tooth strip 2812 which can be configured similarly as gear tooth strip 2800 described with reference to FIG. 28A. According to some embodiments, in the configuration shown in FIG. 28B: (1) arc gear sidewalls are constructed of one part used four times and riveted together, which arrangement can reduce cost in tooling and material waste; and (2) arc gear teeth are made from one shorter tooth strip used three times, which arrangement can reduce cost in tooling. FIG. 28C shows an exemplary embodiment of a four-part arc gear (arc gear including or made up of four sidewall pieces according to some embodiments) that includes a front half-arc section 2820, a back half-arc section 2821, a seam 2822 between arc gear sections, and rivets 2823 attaching sections.

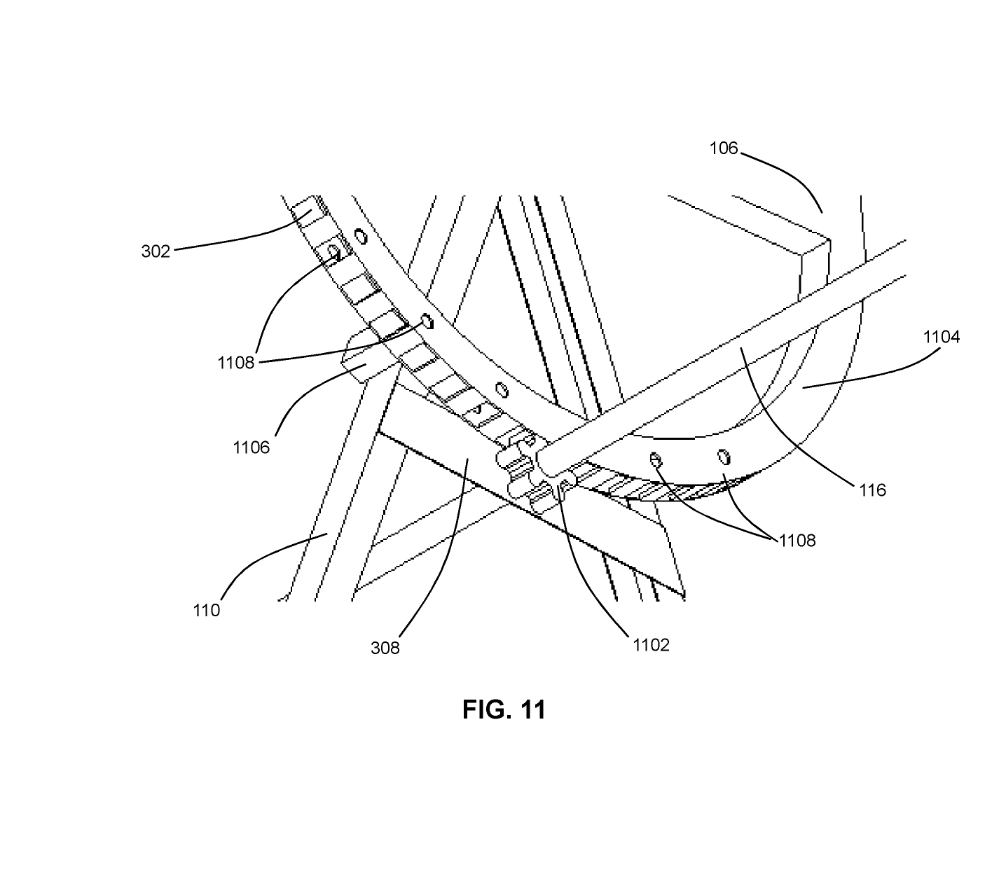

FIG. 11 schematically illustrates an alternative exemplary configuration of the solar tracker locking mechanisms such as illustrated in FIGS. 2 through 6. In exemplary configuration illustrated in FIG. 11, the solar tracker can be configured similarly as in FIG. 1, except for the locking mechanism. For example, two sets of legs 110 can be stiffened by ties 308 and can support sets of pivot arms 106 that carry the solar panels (not specifically illustrated in FIG. 11). A drive shaft 116 can be configured so as to transmit torque from a motor (not specifically illustrated in FIG. 11). A pinion gear 1102 can be coupled to the drive shaft 116 so as to transfer torque from the drive shaft 116 to an arc gear 1104. As in earlier exemplary configurations, the arc gear 1104 can be locked in place during high wind events such that the drive shaft and motor can be specified for a lower torque rating than in a configuration in which the drive shaft and motor instead are configured so as to withstand the higher, design-point wind speed; as such, significant cost can be saved as compared to such configurations.

Continuing with the exemplary configuration illustrated in FIG. 11, an electric slide-lock mechanism 1106 can be provided and configured so as to lock the arc gear 1104 in place. The arc gear 1104 can be configured similarly as the arc gear 120 in FIG. 1, except that in the configuration of FIG. 11 the gear teeth 302 can be configured so as to continue all along the arc; additionally, or alternatively, the arc gear 1104 can include one or more holes 1108 provided on the side of the gear. These holes can be located on a circle that is concentric with the rotational axis of the pivot arm 106. The holes can be round, rectangular, or another suitable shape.

Further details of an exemplary configuration of the slide-lock mechanism 1106 are schematically illustrated in detail in FIG. 12. As illustrated in FIG. 12, slide-lock mechanism 1106 can include a gear box 1202 and a locking bolt 1204. The locking bolt 1204 cross-sectional shape can correspond in shape to the holes 1108 in the arc gear 1104 and can be, for example, round, rectangular, or another suitable shape. The gear box 1202 can include an electric motor configured so as to provide rotary power and drives gears which provide output shaft power with reduced rotational speed and increased torque relative to the motor shaft speed and torque. The gear box 1202 also can include a rack and pinion gear set (not specifically illustrated) that can convert rotary motion to linear motion and that can translate the locking bolt 1204 outward or inward from the gear box 1202. Slide-lock mechanism 1106 suitably can include an electric linear actuator, a pneumatic cylinder, a hydraulic cylinder, or another suitable type of actuator configured so as to translate the locking bolt 1204 outward or inward from the gear box 1202.

Referring again to FIG. 11, the slide-lock mechanism 1106 can be aligned such that the locking bolt 1204 can slide into the one or more holes 1108 on the arc gear 1104, and can be mounted on the solar tracker's leg set 110 or at another suitable location. Based upon the locking bolt 1204 being retracted into the gear box 1202, the arc gear 1104 can be rotated by the drive shaft 116 via the pinion gear 308. Based upon the locking bolt 1204 being extended into one of the holes 1108 on the arc gear 1004, the arc gear and therefore the solar tracker can be locked in place. Wind forces on the solar panels thus can be transferred into the locking mechanism 1106 and into the leg set 110 and structure of the solar tracker rather than into the drive shaft 116.

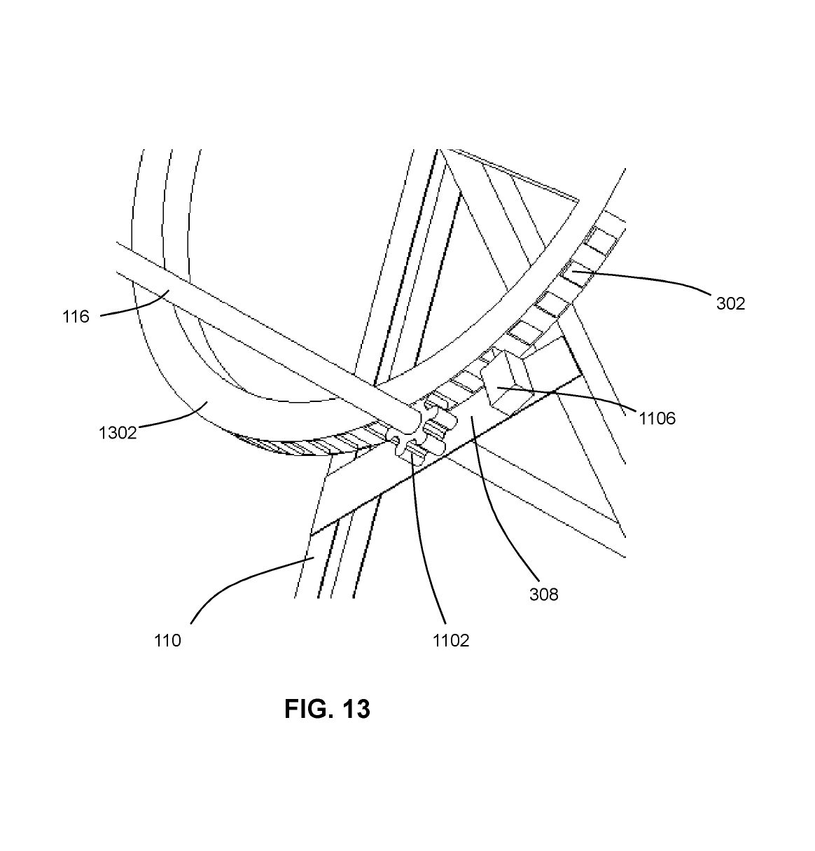

FIG. 13 schematically illustrates a perspective view of an alternative locking mechanism exemplary configuration. In this exemplary configuration, a drive shaft 116 is rotatably coupled to a pinion gear 1002 which engages with and is rotatably coupled to an arc gear 1302 via gear teeth 302. Similarly as in FIG. 1, the arc gear 1302 is configured so as to support and rotate solar panels (not specifically illustrated in FIG. 13), and leg sets 110 stiffened by ties 308 are configured so as to support these elements. In this exemplary configuration, the slide-lock mechanism 1106, which can be configured such as illustrated in FIG. 12, can be positioned and oriented so that the locking bolt 1204 (not specifically illustrated in FIG. 13) can be translated by gear box 1202 so as to be extended to engage with the teeth 302 of the arc gear 1202. Optionally, the locking mechanism 1106 can be mounted on the tie 308 or other structural member of the assembly such as the leg set 110. Based upon the locking bolt 1204 being retracted into the locking mechanism 1106, the arc gear 1302 can rotate, driven by the drive shaft 116, via the pinion gear 1102. Based upon the locking bolt 1204 being translated so as to be extended into the arc gear's teeth 302, then the arc gear 1302 can be locked in place. In this position, torque from wind forces on the solar panels can be resisted by the locking mechanism 1106 and the solar tracker's structure rather than by the drive shaft 116 and driving motor.

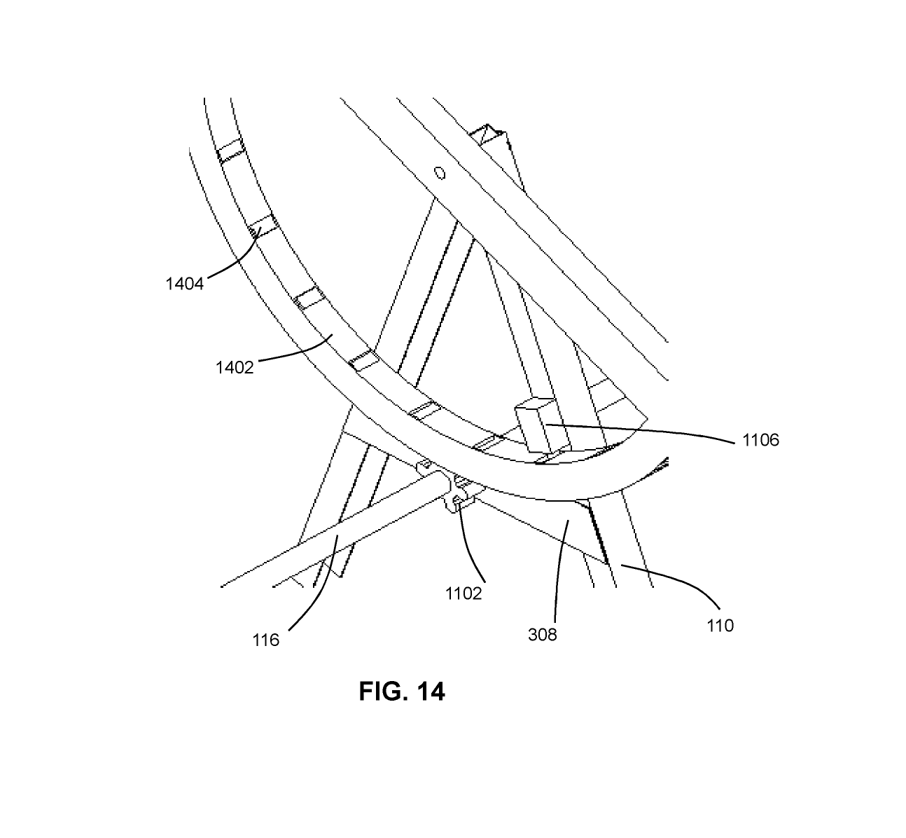

FIG. 14 schematically illustrates a perspective view of another alternative exemplary configuration of a solar tracker locking mechanism. In the configuration illustrated in FIG. 14, drive shaft 116 can be rotatably coupled to a pinion gear 1102 that engages with and is rotatably coupled to an arc gear 1402. Similarly as in FIG. 1, the arc gear 1402 can be configured so as to support and rotate solar panels (not specifically illustrated in FIG. 14), and leg sets 110 stiffened by ties 308 can be configured so as to support these elements. In the exemplary configuration illustrated in FIG. 14, the arc gear 1402 can include one or more holes 1404 on the inside surface of the gear. A slide-lock mechanism 1106 such as illustrated in FIG. 12 can be positioned and oriented such that the locking bolt 1204 can extend into one of the arc gear's holes 1404. The slide lock mechanism 1106 optionally can be mounted on one of the legs 110 or on another structural component of the solar tracker. Similarly as in the exemplary configurations in FIG. 11 and in FIG. 13, the locking mechanism 1106 can be configured so as to lock the arc gear 1402 in place to resist torque caused by wind forces on the solar panels.

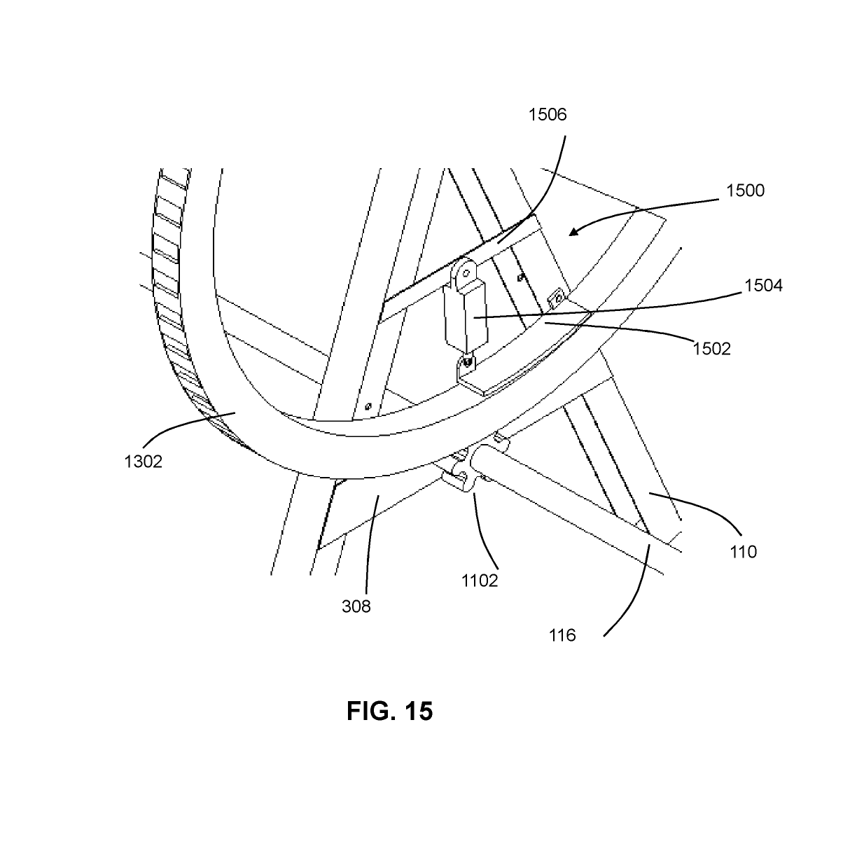

FIG. 15 schematically illustrates a perspective view of another exemplary configuration of a solar tracker locking mechanism. In the example illustrated in FIG. 15, a drive shaft 116 can be rotatably coupled to a pinion gear 1102 which engages with and is rotatably coupled to an arc gear 1302. Similarly as in FIG. 1, the arc gear 1302 can be configured so as to support and rotate solar panels (not specifically illustrated in FIG. 15), and leg sets 110 stiffened by ties 308 can be configured so as to support these elements. In the exemplary configuration illustrated in FIG. 15, a drum brake system 1500 is configured so as to lock the solar tracker in place. The drum brake system 1500 can include a brake shoe 1502, an actuator 1504, and a mounting brace 1506. The brake shoe 1502 can be mounted at one end on one of the tracker legs 110 or on another structural component. The brake shoe 1502 can be configured so as to rotate about such a mounting point such that, depending on the position of the brake shoe, the brake shoe can either not touch the inside of the arc gear 1302 or can press against the inside of the arc gear 1302. The brake shoe 1502 can be curved such that its curvature matches a curvature of the arc gear 1302. The brake shoe 1502 can be configured such that when pressed against the arc gear 1302, the brake shoe applies sufficient normal force to generate friction to lock the arc gear in place. The brake shoe 1502 can be configured so as to be rotated by an actuator 1504 which, in some configurations, can move in a linear fashion. The actuator 1504 can be or include, for example, a linear motor, a rotary motor with a gear box, a pneumatic piston, a hydraulic piston, and/or another element that is configured so as to selectively press the drum shoe 1502 against the arc gear 1302. In one example, one end of the actuator 1504 can be coupled to the brake shoe 1502 and on the other end of the actuator can be coupled to a mounting brace 1506 or other suitable structure. At one or both mounting points, the actuator can be configured so as to rotate freely so as to allow for its changing angle as it engages or disengages the brake shoe 1502.

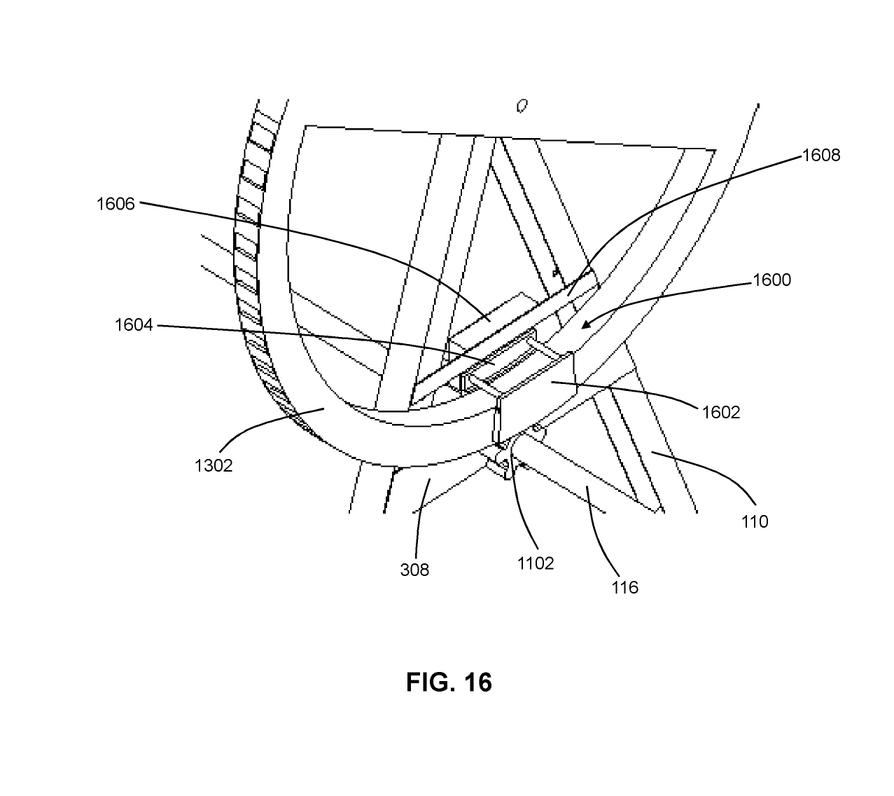

FIG. 16 schematically illustrates a perspective view of yet another exemplary configuration of a solar tracker locking mechanism. In the configuration illustrated in FIG. 16, drive shaft 116 can be rotatably coupled to a pinion gear 1102 that engages with and is rotatably coupled to an arc gear 1302. Similarly as in FIG. 1, the arc gear 1302 can be configured so as to support and rotate solar panels (not specifically illustrated in FIG. 16), and leg sets 110 stiffened by ties 308 can be configured so as to support these elements. In the exemplary configuration illustrated in FIG. 16, a caliper brake system 1600 can be configured so as to lock the solar tracker in place. The caliper brake system 1600 can include two calipers 1602, 1604 pressing on respective sides of the arc gear 1302. Calibers 1602, 1604 can be configured so as selectably to apply sufficient normal force to lock the arc gear 1302 in place via friction. The caliper brake system 1600 can include an outside caliper 1602, an inside caliper 1604, an actuator 1606, and a mounting bracket 1608. The outside caliper 1602 can include a first pad to press against the arc gear 1302 and one or more rods, e.g., two rods, configured to connect the first pad to the actuator 1606. The inside caliper 1604 can include a second pad and one or more rods, e.g., a rod, configured to connect the second pad to the actuator 1606. The actuator 1606 can be configured so as to simultaneously and selectably move both the inside caliper 1604 and the outside caliper 1602 toward and press against the arc gear 1302 or away from the arc gear 1302. The actuator 1606 can be or include a hydraulic system, a pneumatic system, a set of two linear motors, a single linear motor that is geared to move both calipers at the same time, a rotary motor with a gear box and rack and pinion system to move both calipers, or another suitable type of actuator. The actuator 1606 can be mounted on the mounting bracket 1608, which can be mounted on the leg set 110 or another structural member of the solar tracker.

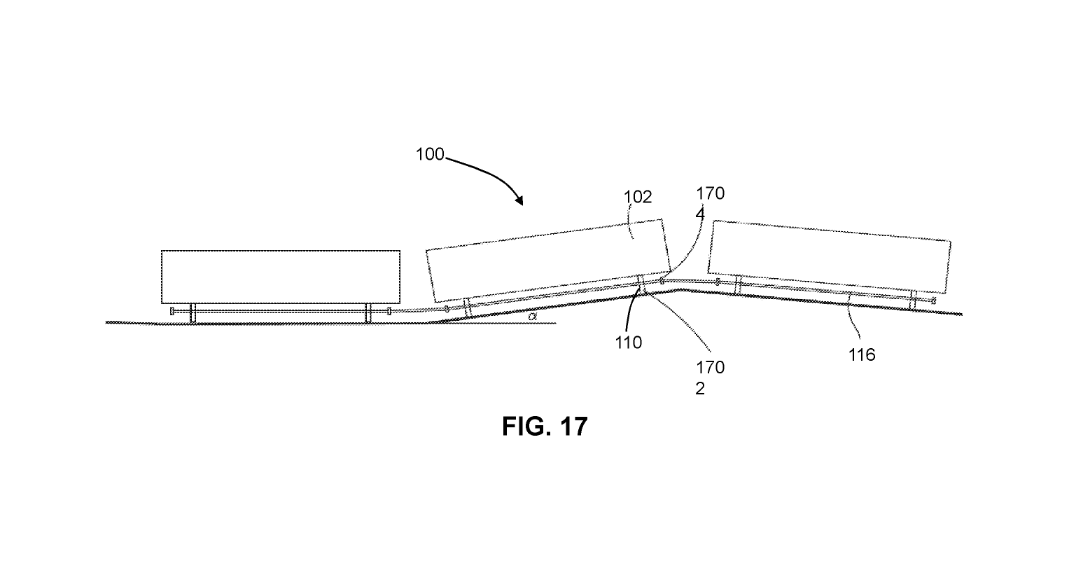

FIG. 17 schematically illustrates an exemplary configuration including multiple sections of solar trackers coupled together. A coupling 1702 connects the drive shafts 116 of adjacent tracker sections. The orientable coupling joints 1704 can be installed at an angle with respect to each other such that the tracker row can be placed over uneven terrain and can follow contours without the need for extensive site preparation.

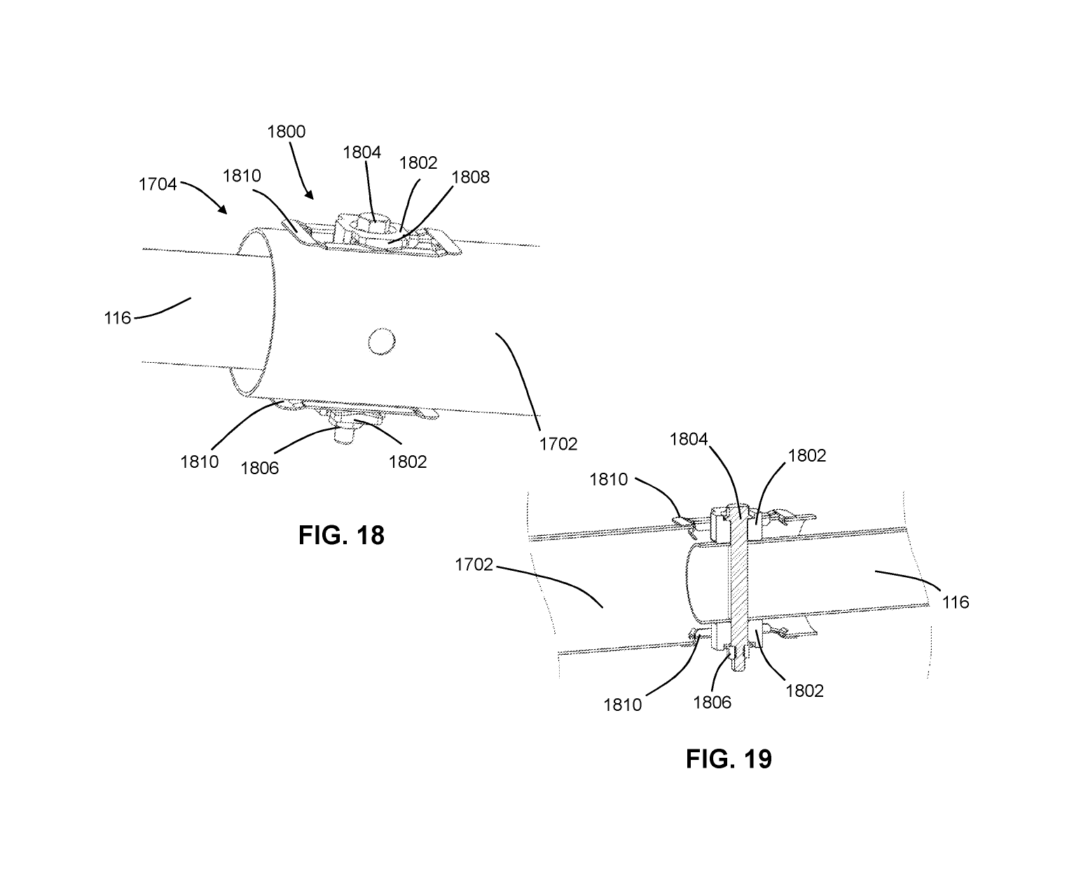

FIG. 18 schematically illustrates an exemplary coupling joint compatible, for example, with the configuration illustrated in FIG. 17. FIG. 19 schematically illustrates a cross-sectional view of the exemplary coupling joint illustrated in FIG. 18. For example, FIG. 18 is a detailed view of an exemplary coupling joint 1704, and FIG. 19 schematically illustrates a cross-sectional view of the same exemplary configuration as illustrated in FIG. 18. The coupling joint 1704 illustrated in FIGS. 18-19 can include the coupling 1702, a pin assembly 1800, and a drive shaft 116, which drive shaft 116 optionally can correspond to the drive shaft 116 described above with reference to FIG. 1 and FIG. 11. The cross section of the coupling 1702 and the drive shaft 116 can each independently be cylindrical, rectangular, or another shape. The drive shaft 116 can be configured so as to be slid partly inside the coupling 1702. The coupling 1702 and the drive shaft 116 each can include a rectangular slot cut therethrough, and bushings 1810 can be inserted into these slots. The pin assembly 1800 can be configured so as to pass through the respective slots and rotatably couple the coupling 1702 to the drive shaft 116. The pin assembly 1800 and rectangular bushings 1810 can be configured so as to provide translational motion between the coupling 1702 and the drive shaft 116. The pin assembly 1800 and rectangular bushing 1810 can also provide limited rotational motion about the axis of the pin assembly 1800 and/or about an axis that is perpendicular to the axis of the pin assembly 1800 and the axis of the coupling 116.

Continuing with FIGS. 18 and 19, the pin assembly 1800 can include two end pieces 1802, a bolt 1804, and a nut 1806. The bolt 1804 and nut 1806 can be configured so as to hold the two end pieces 1802 together. Optionally, the end pieces 1802 can include bearing surfaces 1808, that optionally are substantially triangular in shape, that are configured so as to allow sliding contact bearing between them and the bushing 1810 when the coupling 1702 and drive shaft 116 are not aligned with one another. The coupling in this exemplary configuration can accommodate thermal movement, installation tolerance, and uneven terrain. In some configurations, the flexible coupling such as shown in FIGS. 18-19 is designed for use with round tubes, can be made from or include sheet metal, and/or can include a pin assembly that is made up of or that includes two pieces that are connected by a bolt. For example, reducing or minimizing the number of parts can reduce system cost.

FIGS. 21A and 21B schematically illustrate perspective views of an alternative exemplary configuration of a solar tracker. FIG. 21A schematically illustrates a perspective view, and FIG. 21B schematically illustrates a detailed perspective view. This exemplary configuration includes solar panels rotated about a tracking axis that is parallel to the earth's surface and aligned in the North-South direction. Solar panels 2102 can be aligned along the tracking axis, and can be mounted on a rotary beam 2104. The rotary beam in FIGS. 21A and 21B includes a square cross section, but the shape could be round or another shape. The rotary beam 2104 can be aligned with the tracking axis. Stiffeners behind the panels can increase the structural stiffness in the direction transverse to the tracking axis. The assembly of solar panels 2102, stiffeners, and rotary beam 2104 can be supported by bearings 2106 on posts 2108. The bearings 2106 can be configured so as to allow the rotary beam to rotate about the tracking axis. The arc gear and offset drive shaft can be configured so as to reduce or remove torque from the rotary beam, such that the rotary beam can be prepared with reduced strength, materials, and/or cost than in configurations where the rotary beam otherwise would bear some or all of such torque. The posts 2108 can be mounted on ground screws, ground nails, concrete ballast, concrete foundations, or any other type of foundation or support structure.

Continuing with FIGS. 21A and 21B, the solar tracker can be driven by a motor (not specifically illustrated) which drives a drive shaft 2010, which can be mounted on the posts via drive shaft bearings 2112, which also can be referred to as bearing mounts. The drive shaft 2110 can be coupled to pinion gears 2114, which can be configured similarly as in the exemplary configuration in FIG. 7 or in FIG. 2, so as to transfer torque and power to arc gears 2116. The arc gears 2116 can be mounted on stiffeners 2118 that can be configured so as to transfer torque and power from the arc gears 2116 to the torque tube 2104. The exemplary configuration in FIGS. 21A and 21B includes two arc gears 2116 in each solar tracker section, but in other configurations only one arc gear 2116 can be provided per section 2116, or less than one arc gear per section can be provided. As an example, the rotary beam 2104 can be extended through multiple sections, and one arc gear 2116 can be provided for every third section. The solar tracker can be locked for high wind events with a locking mechanism, including the pinion gear 2114, the lock plate 2120, and the arc gear 2116, which can be configured similarly as described for the exemplary configuration in FIGS. 1-7C.

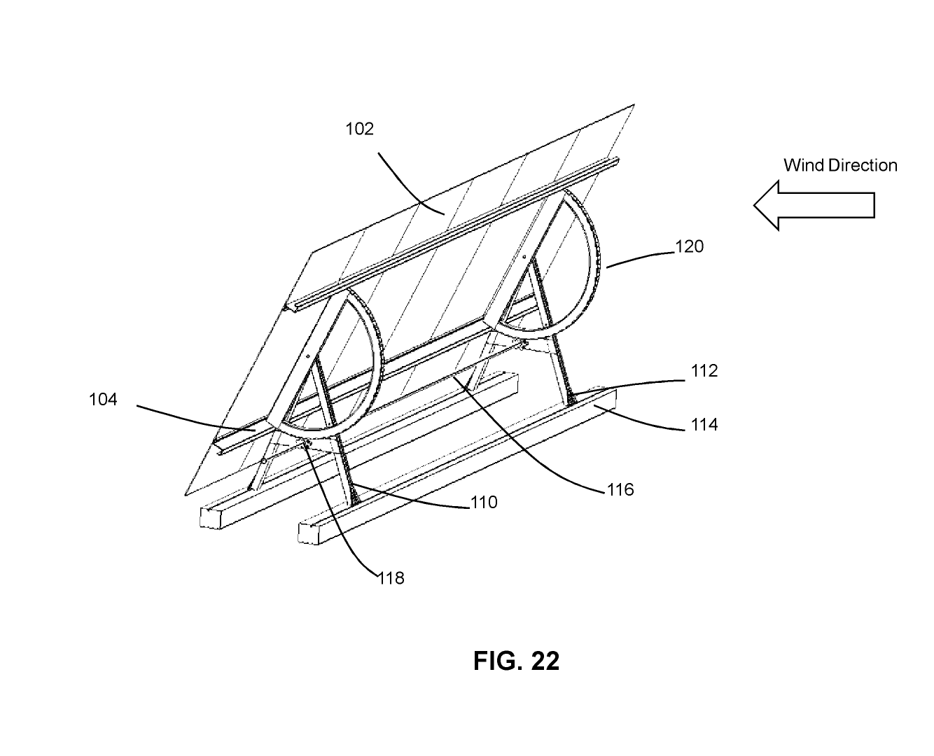

A “stow position” for a solar tracker can be considered to be a position in which the tracker is moved to such a position that it can resist wind forces with special strength or that the wind forces are significantly reduced. A tracker can include one or more than one stow position. FIG. 22 schematically illustrates a perspective view of an exemplary configuration of a solar tracker locking mechanism in a stow position. For example, FIG. 22 schematically illustrates the exemplary solar tracker locking mechanism configuration of FIG. 1 in a stow position. This stow position is characterized by the tracker having rotated solar panels 102 away from the prevailing wind (wind direction represented by large arrow). For example, the tracker can rotate the panels until the leeward purlin 104 contacts the legs, e.g., two sets of legs 110, and becomes braced against these legs. In this position, wind forces against the backs of the solar panels can result in force being transmitted from the leeward purlin 104 to the legs 110 and into the ground. This can reduce, inhibit, or avoid wind forces on the solar panels 102 transmitting torque into the drive shaft 116 (and thus into the drive motor). Furthermore, wind forces on the solar panels 102 in a group of solar collector sections 100 can be distributed into all of the leg structures 110 rather than being concentrated into any one mechanical element. The solar tracker can rotate in either direction to brace a purlin 104 against the leg sets 110, and a tracker control system (not shown) optionally can choose which direction to stow, for example, depending on the prevailing wind direction. An exemplary angle of the stow position is 60 degrees with reference to the east or the west. Optionally, a purlin or other moveable part can be in contact with a fixed structure such as an A-frame (leg set) or leg. For example, in a stow position such as illustrated in FIG. 22, the purlin is in contact with the A-frame according to some embodiments. For example, there can be a cushion element, spring, bumper, damper, or other mechanism to resist potential shock of the purlin hitting the A-frame. In another example, the contact between the purlin and A-frame provides additional strength to the structure for resisting wind forces or other forces. Arc tracker restrained stow can reduce or eliminate galloping, can reduce or eliminate/minimize stow torque on drive system, and/or module/rotating part of structure is pinned to (i.e., pressed against) a frame, no load reversal effects. A bumper spring optionally can be disposed between the purlin 104 and A-frame leg set 110 so as to reduce impact. According to some embodiments, various configurations include: spring, bumper, or damper. In examples of stow statics (load on rotating part of structure), a wind resultant against the back of solar panels 102 causes a force (Fr) that reacts against a pivot pin, which force (Fr) presses against the (stationary) leg/frame.

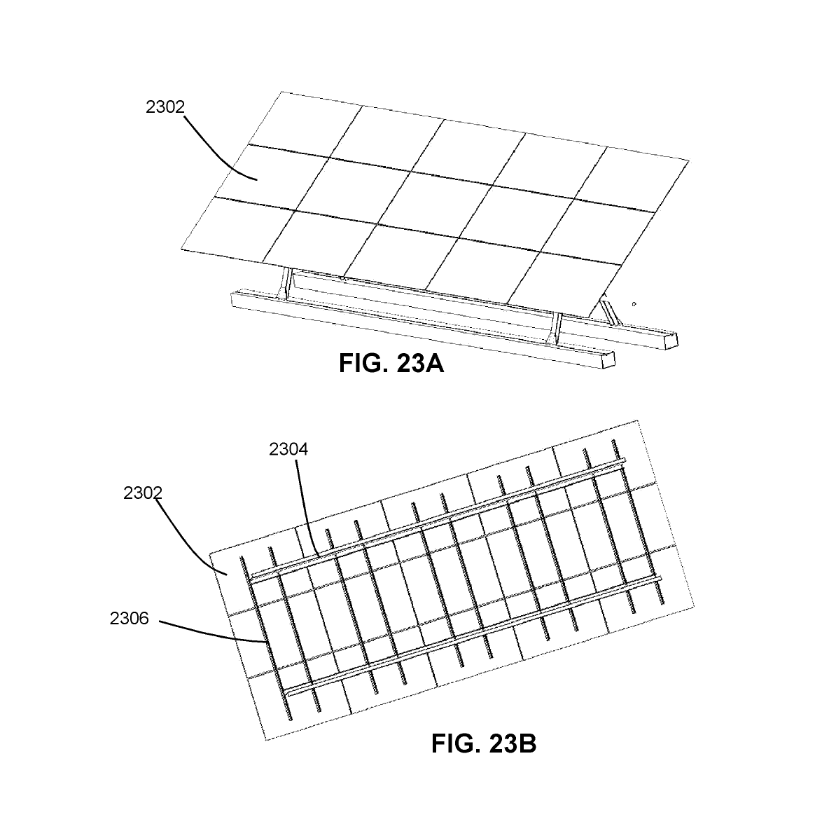

FIG. 23A schematically illustrates a perspective view of an alternative exemplary configuration of a solar tracker, and FIG. 23B schematically illustrates a plan view of an exemplary solar panel assembly compatible with the solar tracker of FIG. 23A. For example, FIGS. 23A-23B illustrate an alternative configuration to the solar tracker section in FIG. 1. In the nonlimiting example shown in FIGS. 23A-23B, three solar panels 2302 are mounted across the width of the tracker. FIG. 23B shows an exemplary subassembly of purlins 2304 with a series of frame elements 2306 fastened cross-wise on the purlins (e.g., perpendicular to the purlins). The solar panels 2302 optionally can be mounted via an adhesive on the frame elements 2306. Clips or fasteners alternatively or additionally can be used to mount the panels 2302 onto the frame elements 2306. In the configuration shown in FIGS. 23A-23B, three panels are mounted across, but the number of panels could be two or it could be more than three. Additionally, in the configuration shown in FIGS. 23A-23B, five panels are mounted length-wise along the tracker; any other number of panels can be mounted on the tracker. According to some embodiments, a certain number of the modules are grouped into one structural unit using stiffeners (frame elements 2306). For example, in the case shown in FIGS. 23A-23B, a group can include or consist of three modules, but the group may contain any suitable number of modules. In another example, the stiffeners (frame elements 2306) that support the group of modules are attached to the arc tracker purlins (e.g., purlins 2304). In yet another example, modules may be attached to the stiffeners with an adhesive material.

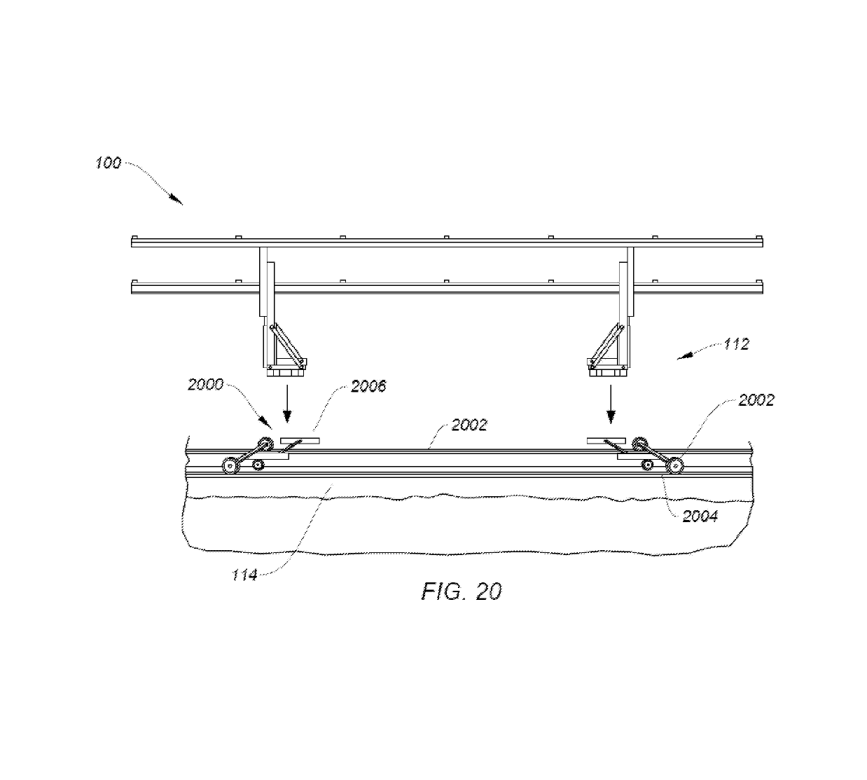

FIG. 20 schematically illustrates an exemplary cart for transporting a tracker frame along a length of a track. For example, an exemplary feature of the solar trackers 100 provided herein is that they can be relatively fast and easy to assemble. One aspect of this is that a cart 2000, such as illustrated in FIG. 20, can be used to transport the tracker frame 100 along a length of the concrete ballast 114, optionally which can be configured in a manner such as illustrated in FIG. 17. In one exemplary method of preparing a solar tracker, the concrete ballast tracks 114 can be formed. A tracker frame 100 can be prepared in an assembly space, which space optionally can be located at the end of concrete ballast track 114. The prepared tracker frame 100 can be placed onto a cart 2000 such as illustrated in FIG. 20, and the cart then moved lengthwise down the concrete track 114 to a location where the tracker frame is to be deployed. Such a cart system can facilitate installations because, for example, the concrete track can be relatively long.

In one exemplary configuration, the cart 2000 illustrated in FIG. 20 includes a frame 2002 and two sets of wheels 2002 and 2004 which can be configured such that the cart frame can roll along the concrete track and stay aligned with the track. The cart 2000 can include four foot supports 2006 which are designed to receive and support the tracker's feet 112. The cart can be moved by being pushed or pulled by hand, or can be configured so as to be powered by an electric motor or other actuation system.

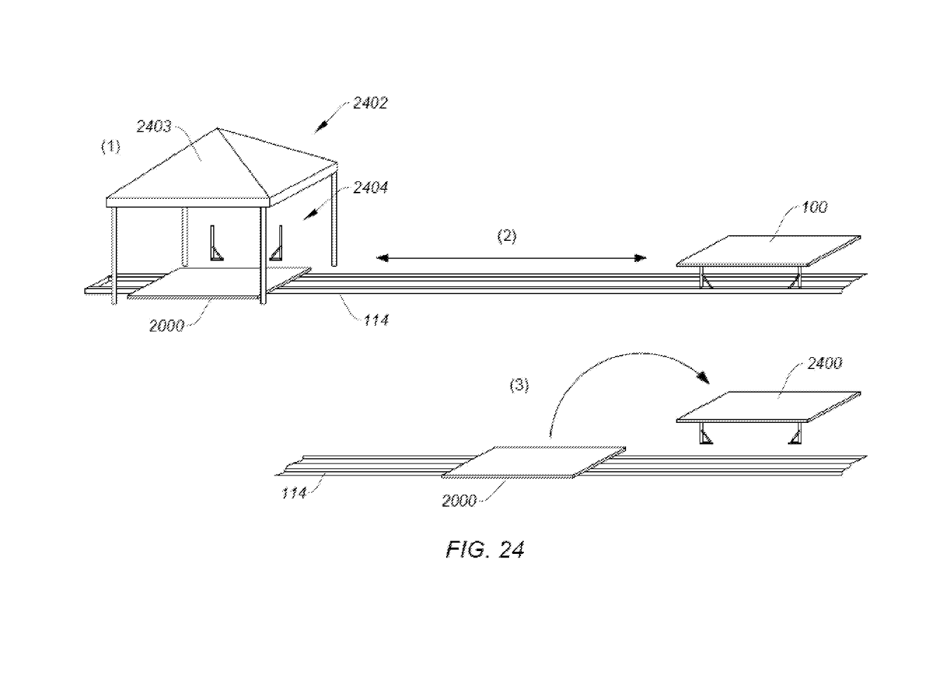

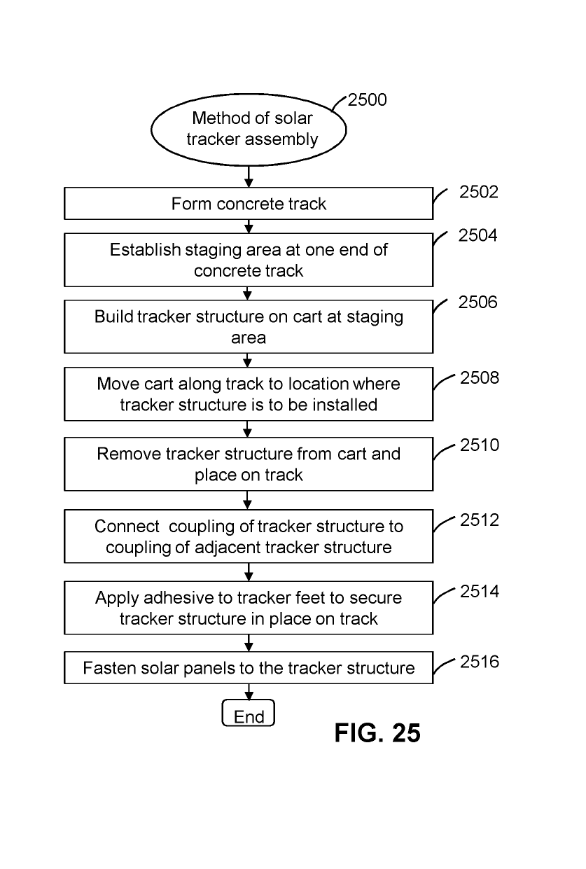

FIG. 24 schematically illustrates certain components during an exemplary method for assembling a solar tracker. For example, FIG. 24 includes a diagram of steps (1)-(3) that in some configurations correspond to certain steps of the method 2500 described below with reference to FIG. 25. An example processes includes assembling arc tracker sections at an end of a rail and transporting using an on-rail cart. Steps can include (1) assemble table at end of rail; (2) move table into position using cart; and (3) remove table from cart and place on track. A table can be or include the racking assembly for a group of solar modules, e.g., PV modules. The diagram in FIG. 24 schematically illustrates certain elements of the solar power plant site during construction, which site can include tracks, e.g., concrete tracks 114. At or near an end of a concrete track 114 can be provided a staging area 2402 that optionally can include a shade structure over a table assembly area, such as tent 2403. At the staging area 2402, solar tracker structures can be assembled. For example, a partly assembled structure 2404 is shown being assembled on a cart 2000 at step (1), optionally which cart can be configured similarly as in FIG. 20, and which cart can be used for moving an assembled table. For example, the resulting assembled structure 2400 can be moved by cart 2000 at step (2) (corresponding to cart movement) along the track 114 to a suitable location, such as adjacent a previously installed, assembled table 100. The assembled structure 2400 can be moved from the cart 2000 onto the track 114 at step (3).

FIG. 25 schematically illustrates a flow of steps in an exemplary method 2500 for assembling a solar tracker. Method 2500 can include forming a concrete track (2502). For example, a track 114 such as described above with reference to FIG. 1 can be formed using slip-forming or extrusion, and can include a single concrete ballast (track) that provides first and second surfaces configured for a cart to roll along, or two separate concrete ballasts (tracks), e.g., a first ballast that provides a first surface configured for a cart to roll along, and a second ballast that provides a second surface configured for a cart to roll along. A staging area can be established at one end of the track (2504), e.g., a staging area 2402 such as described above with reference to FIG. 24. In method 2500, a tracker structure (e.g., table) can be built on a cart at the staging area (2506), e.g., structure 2400 can be partially assembled and then completely assembled on cart 2000 at staging area 2402 in a manner such as described above with reference to step (1) of FIG. 24. Method 2500 also can include moving the cart along the track to a location where the tracker structure is to be installed (2508), e.g., cart 2000 with assembled structure (table) 2400 disposed thereon can be rolled along first and second surfaces of track 114, to a suitable location, e.g., a location adjacent to a previously installed, assembled table 100, in a manner such as described above with reference to step (2) of FIG. 24. For example, in one nonlimiting configuration, workers push the cart down the track to where the tracker structure is intended to be installed. Method 2500 also can include removing the tracker structure from the cart and placing the structure on the track (2510), e.g., assembled table 2400 can be removed from cart 2000 and suitably placed on track 114 such as described above with reference to step (3) of FIG. 24. For example, in one nonlimiting configuration, workers can pick up the structure (table) and put it on the track. In some configurations, feet 112 of the tracker structure are inserted into grooves of track 114. Method 2500 also can include connecting a coupling of the tracker structure to a coupling of an adjacent tracker structure (2512), e.g., a coupling of assembled table 2400 can be connected a coupling of assembled, previously installed table 100 illustrated in FIG. 24. Exemplary couplings are described herein with reference to FIGS. 18 and 19. Such connecting optionally can be performed by workers. Method 2500 also includes applying adhesive to tracker feet to secure the tracker structure in place on the track (2514). For example, in some configurations in which the feet 112 of the tracker structure are inserted into grooves of track 114, adhesive can be applied within the groove, for example by workers, so as to fasten the tracker in place. Method 2500 also can include fastening solar panels to the tracker structure (2516), for example before or after the tracker has been placed on the tracker and/or secured in place with adhesive. Alternatively, the solar panels can be fastened to the tracker structure at the staging area and the tracker structure, with solar panels attached, can be moved with the cart to the installation location and there installed. Method 2500 can be repeated any suitable number of times for any suitable number of tracker structures (tables) so as to prepare an elongated array (row) of solar trackers.

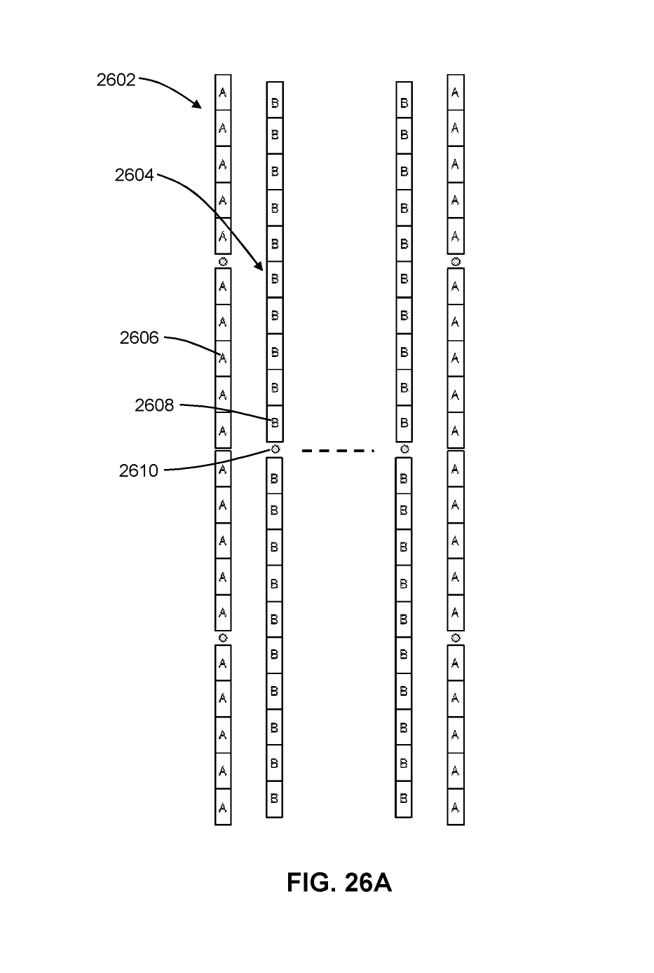

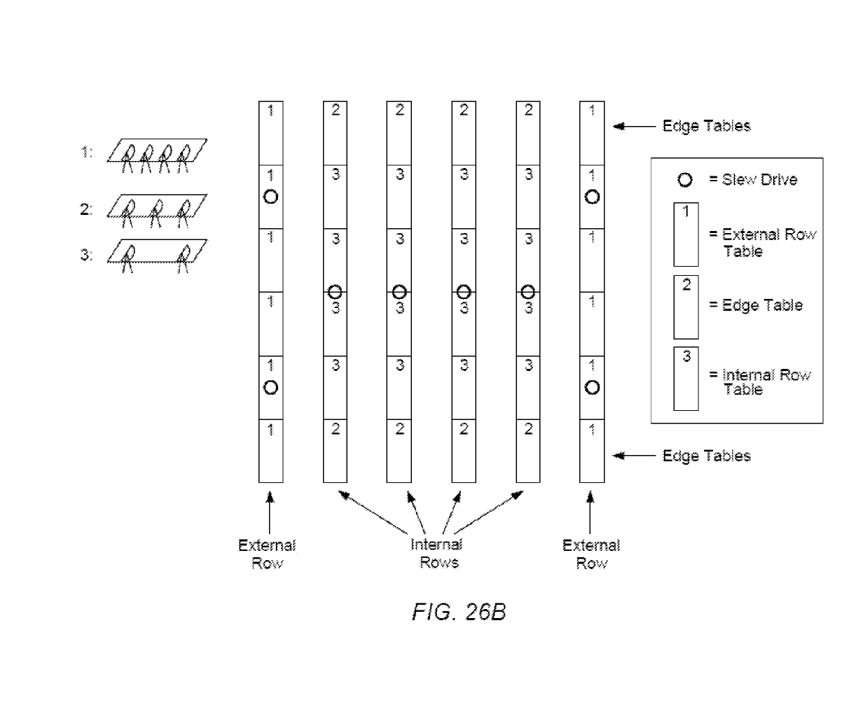

According to certain embodiments, an arc tracker distributed foundation can allow the mechanical loads on the arc tracker system components to be reduced or minimized. For example, supports (legs) can be placed at smaller intervals such that each support does not bear as much stress as in the case of larger intervals. In another example, on exterior rows with higher wind loading, more supports can be installed rather than increasing the size and/or strength of supports. Various nonlimiting examples, such as shown in FIGS. 26A-26B, can include (1) external rows—four A-frames (leg sets) per table, 2 slew drives per row, and drive shafts; (2) edge tables—three A-frames per table; and/or (3) internal rows—two A-frames per table, 1 slew drive per row, and selected drive shaft wall thickness.

FIGS. 26A-26B schematically illustrate plan views of exemplary layouts of solar trackers, optionally which can be installed in a manner such as described herein with reference to FIGS. 24 and 25. The layout illustrated in FIG. 26A includes two external rows 2602 that are on the outside of the solar field and any suitable number of internal rows 2604 that are between the external rows (two internal rows 2604 are shown in FIG. 26 for clarity). Solar trackers can be configured so as to withstand wind forces. In a large solar field, the external rows tend to shield the internal rows from wind forces so these internal rows can experience significantly different forces than the external rows. As provided herein, one optional way to reduce capital cost for installing the solar trackers is to design the external rows and internal rows to be different from one another since they face different wind forces. For example, in the nonlimiting configuration illustrated in FIG. 26, tracker sections can be designed differently and the number of sections per motor can be different in internal rows 2604 versus external rows 2602. In FIG. 26A, each small rectangle represents a tracker section which can be configured similarly as tracker 100 described above with reference to FIG. 1. In one exemplary configuration, the rectangles 2606 labeled “A” in external rows 2602 can include three leg sets 110 per section, and the rectangles 2608 labeled “B” in internal rows 2604 can include two leg sets 110 per section. In such a manner, the external rows 2602 can have greater structural strength than the internal rows 2604, while the internal rows 2604 can be prepared at lower cost than the external rows 2602 while having sufficient strength in view of the lower wind forces experienced by the internal rows 2604. Additionally, or alternatively, row motors 2610 can be placed in a higher quantity on external rows 2602 than on internal rows 2604, thereby reducing the number of tracker sections per motor on external rows. Reducing the number of sections per motor increases the overall stiffness of the mechanical system connected to the motor. The layout in FIG. 26B includes external rows with two slew drives each, wherein each table of the external row can include four A-frames, and internal rows with one slew drive each, wherein tables at the edge of the internal row each can include three A-frames and tables that are internal to the internal row can include two A-frames. It should be appreciated that any suitable number of A-frames (or other leg sets) and slew drives (or other row motors) can be used.

Exemplary connections between row motors (e.g., slew drives) and rows of tracker sections for rotating the tracker sections are described in International Patent Publication No. WO 2016/187044, published Nov. 24, 2016 and entitled “Systems and Methods for Rotating Photovoltaic Modules,” the entire contents of which are incorporated by reference herein.

In exemplary configurations, elements of cart-based assembly can include an assembly area corresponding to a location where racking components are assembled and a transport cart corresponding to a cart that is used to transport materials around a project site or serve another purpose. The assembly area can include an end of rail or designated area. For example, an assembly area may be located at the end of a rail or at another designated location on a project site. Activities at an assembly area may include attaching stiffeners to modules, assembling arc tracker sections (e.g., tables), and loading materials on transport carts. The assembly area may also or alternatively be off-site at a manufacturing facility or other location. Some assembly can be performed away from the assembly area, and some assembly can be performed at the assembly area. The transport cart can be on-rail or off-rail. For example, carts can be designed to travel on the concrete track, off of the track, or a combination of the two. Cart path of movement can include that carts may travel around the job site in various patterns, such as alternating directions along the tracks or making back and forth trips to a designated assembly area.

In additional exemplary configurations, the present tracker can utilize a gear reduction between the arc gear and pinion gear according to certain configurations. For example, the gear reduction between the two gears and the friction resisting their rotation can have the effect of counteracting dynamics and oscillations from wind loading. Some examples of dynamics include flutter and galloping. High damping can be used to suppress wind-induced oscillations according to certain embodiments. For example, with gearing, the torques and drive stiffness are low which can make it difficult to introduce high damping (e.g., >30%) without large impacts on cost or motor size. In another example, energy dissipation is instead achieved at each table (and local gear reduction) via material interaction (e.g., metal on metal sliding).

In additional exemplary configurations, the distributed gear actuation for dampening and stiffening of local movable components can provide active positioning of an array of devices which are intended to point in the direction of the sun, as well as any other array of devices which are positioned simultaneously and may require low cost. One application of such and configuration of actuation is on a solar tracking structure. Such a structure can include solar photovoltaic panels attached for the purpose of electricity generation. It is common for investors and power generation companies to build large arrays of solar panels which may output as much power as a utility power plant normally powered by coal, gas, or nuclear sources. A solar utility power plant may range in size from several hundred kilowatts of available output to more than 500 megawatts. One factor driving the market and size of such power plants is the cost of energy produced over its operating lifetime which, because the energy source is free, is largely comprised of the costs of building and maintaining the plant. If the structure that supports the PV panels points the panels in the direction of the sun through each day, then the power output of each panel is increased when compared with panels that are stationary. This decreases the cost of energy produced by the plan if the additional cost of building and maintaining the solar tracking structure is offset by an even larger increase in power output over the life of the power plant.

Recent advancements in utility scale solar tracker technology have focused on reducing the cost of the tracking actuation hardware by increasing the solar collection area actuated by a single microcontroller and motor. The total cost of the tracking actuation system can be reduced by reducing the number of points of possible failure for a particular power output. An exemplary configuration of actuator and tracking structure for this strategy is to place all of the solar collection panels upon a single component which may rotate about one or more axis to track the sun. This single component which rotates about a fixed foundation to track the sun may be referred to as the moving frame. Once it becomes impractical for a single moving frame to carry any more solar collection area, various methods of force transmission are placed between adjacent moving frames. In this way more than 100 kW of solar PV may track the sun when actuated by a single motor and micro controller.

When implementing a solar tracker architecture having a large solar collection area relative to its single controller and actuator, the stiffness of the system can become a significant design and cost factor. With an array of devices whose positions are controlled by a single actuator, the farther away a single device, or point on a device, is away from the actuator the more flexible it can be relative to the actuated position commanded by the actuator. This phenomenon can occur because every material has a modulus of elasticity, which has units of pressure versus strain, and so the farther the component is from the point of fixation (at the actuator) the less force will be required to produce an equivalent deflection. This problem can be solved by simply stiffening the moveable frame component, but doing so is difficult without sacrificing structural efficiency and adding unnecessary expense. If a structure is stiffened by making the same beam elements thicker then it with become much stronger, will have a high strength to demand ratio, and will utilize more material than is required for the application. Another method of stiffening the structure is by increasing its moments of inertia which, for a beam element having the same weight, will yield larger outside dimensions and thinner sections of material. Both methods of stiffening may add cost to the moving array structure. As such, some active positioning arrays have been designed with a careful compromise between the size of collection area (or whatever element needs to be position controlled) per actuator and the additional cost of material which enables a stiff and strong enough structure to meet the performance requirements of the tracked device.

Even though wind loads and deflections of structures can be calculated with modern data and engineering practices, it has been a common occurrence in the PV tracking market that the structures experience elastic deflection resonance at some wind speed which was not well predicted in the design phase of the structure. Much of this is due to the repeating pattern of the arrays in which one elastic moving plane of a segment of an array is up wind of an identical elastic member of the array. This pattern of identical adjacent elastic members of the array causes there to be oscillation feedback transmitted from one member to the next, and the feedback to continue across many adjacent members of the same array. Because of this, many solar tracking structures which have long elastic members that are subject to significant deflection under wind loading utilize oil dampener struts which can eliminate resonant movement of such an elastic member of an array. Again, the addition of an oil damper adds cost, complexity, and further reduces the reliability of such a mechanism which is sensitive to cost.

The distributed gear actuation for dampening and stiffening of local movable components can increase the stiffness of a positioned element which is significantly long distance away from the actuator which provides the reaction for its various positions. Exemplary configurations of the distributed gear actuation architecture can provide position actuation force through a small drive shaft which can be routed from the central actuator to each element of the array to be positioned. Between the drive shaft and each element that is to be positioned there is a gearbox, bearing, and a reduction ratio in the gearing. The gear reduction is such that the drive shaft must pass through a larger angle of deflection for the corresponding angle change of the element to be positioned. An exemplary solar PV tracker which is currently utilizing this distributed actuation architecture has a gear reduction ratio of 9 to 14:1 between the drive shaft and tracked PV panel. The stiffness of the output element (the PV panel) and the fixed element (actuation motor) can vary with the square of the gear ratio if the torsion element (such as the drive shaft) has the same stiffness between compared systems. In addition to the deflection torques being transmitted to the drive shaft through the gear reduction system, there are local reactions at the gearbox bearings which transmit the deflection torque reactions directly to the local bearing which is near the element which is being positioned. This local reaction of the positioned element is unique in that it allows some of the forces applied to the positioned element to be reacted locally in the support for that element. In a system having no local gear reductions for its positioned elements all of the external forces applied to that element which are not translational (which are rotational about the elements bearing support) must be reacted by the control member which is connected directly to the actuation motor. In this way a distributed drive shaft which actuates individual elements of an array through a gearbox may have increased stiffness and distribute reaction to external forces through local support members.

In addition to the increase in stiffness and distribution of loading to local support members, the distributed gear actuation has the advantage of providing a convenient means of energy dissipation locally at each actuation gear. The means of energy dissipation is through the friction between the drive shaft and its support bearings. It may be noted that this friction energy dissipation also occurs when there is no distributed gear actuation architecture, but it has been shown that the friction energy dissipation may be more easily controlled, practically relied upon, and lower cost, with the distributed gear actuation architecture.

Examples related to damping and local gear reduction include an arc tracker: more metal on metal surfaces than a tracker without local gear reduction, thus possibilities for more frictional damping; and/or higher displacement of drive shaft on arc tracker: friction losses in the gear train occur at the locations with highest displacement, and there are also friction losses at locations of low displacement but these are of smaller magnitude

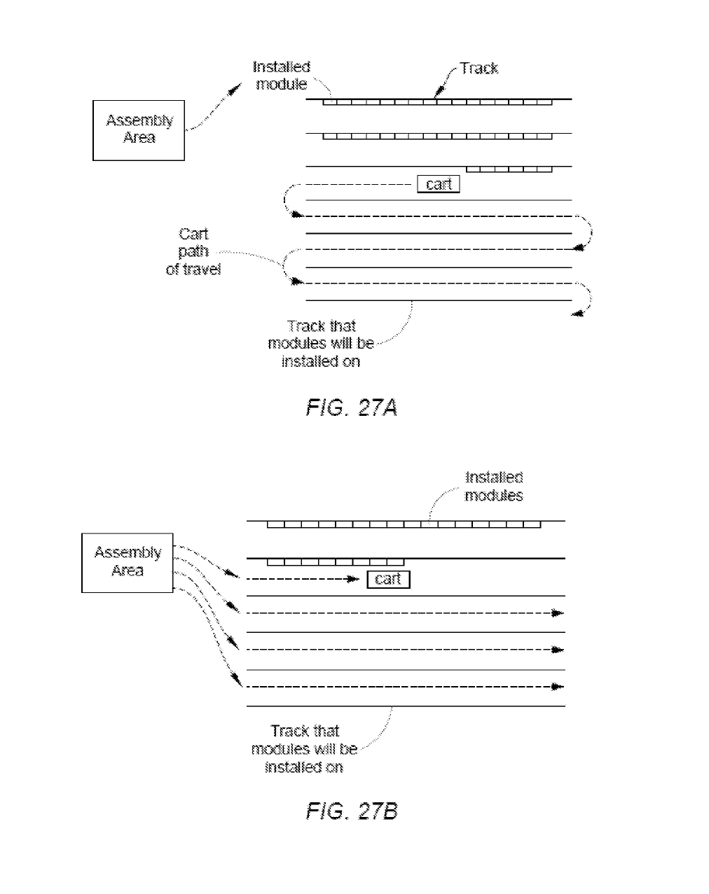

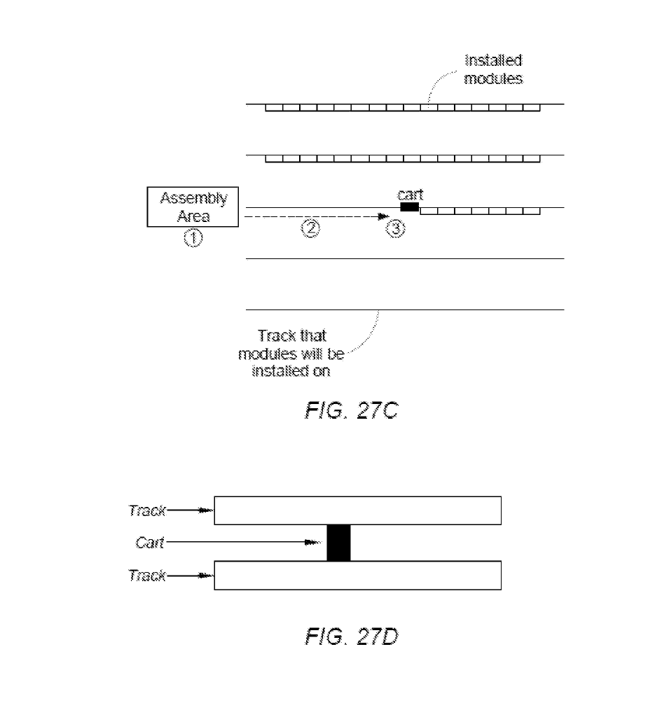

FIGS. 27A-27D schematically illustrate other exemplary configurations of cart-based assembly. The nonlimiting configuration illustrated in FIG. 27A includes a designated assembly area, cart traveling off-rail, and cart alternating directions between rows. The nonlimiting configuration illustrated in FIG. 27B includes a designated assembly area, a cart traveling off-rail, and a cart traveling back and forth between assembly area and rows. The nonlimiting configuration illustrated in FIG. 27C includes an end-of-rail assembly area and cart traveling on rail. In FIG. 27C, (1) the cart is loaded at assembly area at end of the rail, (2) the cart moves to an installation area on the rail, and (3) materials are unloaded from the cart and installed on the rail. In FIG. 27D, the cart rolls along the area between the tracks and is supported by the tracks.

In one nonlimiting configuration, a system for rotatably mounting and locking a solar panel includes a drive mechanism and a locking mechanism. The drive mechanism can include a drive shaft, a pinion gear, and an arc gear. The pinion gear can be coupled to the drive shaft and can include pinion gear teeth and a bearing surface. The arc gear can be coupled to the solar panel and can include a first section. The first section can include arc gear teeth. The locking mechanism can include a lock plate that is coupled to the arc gear and that can include a reaction surface. Responsive to rotation of the drive shaft by a first amount, engagement of the pinion gear teeth with the arc gear teeth in the first section can rotate the arc gear. Responsive to rotation of the drive shaft by a second amount, the arc gear can rotate to a stow position at which the reaction surface bears against the bearing surface and locks the arc gear in place. Nonlimiting examples of such a system are provided herein with reference to FIGS. 1-7C, 10A-10B, 17, 21A-21B, 22, 28A-28C, and 29.

In one nonlimiting configuration, a system for rotatably mounting and locking a plurality of solar trackers can include a first mechanism coupled to a first solar tracker; and a second mechanism coupled to a second solar tracker. The first and second mechanisms each can include a drive mechanism and a locking mechanism. The drive mechanism can include a drive shaft, a pinion gear, and an arc gear. The pinion gear can be coupled to the drive shaft and can include pinion gear teeth. The arc gear can be coupled to the corresponding solar tracker and can include a first section, the first section can include arc gear teeth. The locking mechanism can include a lock plate and a drive pin. The drive pin can be coupled to the pinion gear. The lock plate can be coupled to the arc gear and can include a slot configured to engage the drive pin. The drive shaft of the first mechanism can be flexibly coupled to the drive shaft of the second mechanism. Responsive to rotation of the first drive shaft by a first amount, engagement of the pinion gear teeth of the first mechanism with the arc gear teeth in the first section of the first mechanism rotates the arc gear of the first mechanism; the second drive shaft rotates by the first amount via the flexible coupling; and engagement of the pinion gear teeth of the second mechanism with the arc gear teeth in the first section of the second mechanism rotates the arc gear of the second mechanism. Responsive to rotation of the first drive shaft by a second amount, the slot of the lock plate of the first mechanism engages with the drive pin of the first mechanism and the arc gear teeth of the first mechanism disengage from the pinion gear teeth of the first mechanism; the second drive shaft rotates by the second amount via the flexible coupling; and the slot of the lock plate of the second mechanism engages with the drive pin of the second mechanism and the arc gear teeth of the second mechanism disengage from the pinion gear teeth of the second mechanism. Nonlimiting examples of such a system are provided herein with reference to FIGS. 1-7C, 10A-10B, 17, 18, 19, 21A-21B, 22, 28A-28C, and 29.

In one nonlimiting configuration, a method for rotatably mounting and locking a solar panel can include providing a drive mechanism, which can include a drive shaft, a pinion gear, and an arc gear. The pinion gear can be coupled to the drive shaft and can include pinion gear teeth and a bearing surface. The arc gear can be coupled to the solar panel and can include a first section, the first section can include arc gear teeth. The method also can include providing a locking mechanism can include a lock plate coupled to the arc gear and can include a reaction surface. The method also can include rotating the drive shaft by a first amount such that engagement of the pinion gear teeth with the arc gear teeth in the first section rotates the arc gear. The method also can include rotating the drive shaft by a second amount while engaging the slot of the lock plate with the drive pin such that the arc gear rotates to a stow position at which the reaction surface bears against the bearing surface and locks the arc gear in place. Nonlimiting examples of such a method are provided herein with reference to FIGS. 1-7C, 8, 9, 10A-10B, 17, 21A-21B, 22, 28A-28C, and 29.

In one nonlimiting configuration, a method for rotatably mounting and locking a plurality of solar trackers can include providing a first mechanism coupled to a first solar tracker; and providing a second mechanism coupled to a second solar tracker. The first and second mechanisms each can include a drive mechanism and a locking mechanism. The drive mechanism can include a drive shaft, a pinion gear, and an arc gear. The pinion gear can be coupled to the drive shaft and can include pinion gear teeth. The arc gear can be coupled to the corresponding solar tracker and can include a first section, the first section can include arc gear teeth. The locking mechanism can include a lock plate and a drive pin. The drive pin can be coupled to the pinion gear, and the lock plate can be coupled to the arc gear and can include a slot configured to engage the drive pin. The drive shaft of the first mechanism can be flexibly coupled to the drive shaft of the second mechanism. The method can include rotating the first drive shaft by a first amount such that engagement of the pinion gear teeth of the first mechanism with the arc gear teeth in the first section of the first mechanism rotates the arc gear of the first mechanism. The method can include rotating the second drive shaft by the first amount via the flexible coupling such that engagement of the pinion gear teeth of the second mechanism with the arc gear teeth in the first section of the second mechanism rotates the arc gear of the second mechanism. The method can include rotating the first drive shaft by a second amount such that the slot of the lock plate of the first mechanism engages with the drive pin of the first mechanism and the arc gear teeth of the first mechanism disengages from the pinion gear teeth of the first mechanism. The method can include rotating the second drive shaft by the second amount via the flexible coupling such that the slot of the lock plate of the second mechanism engages with the drive pin of the second mechanism and the arc gear teeth of the second mechanism disengage from the pinion gear teeth of the second mechanism. Nonlimiting examples of such a method are provided herein with reference to FIGS. 1-7C, 8, 9, 10A-10B, 17, 18, 19, 21A-21B, 22, 28A-28C, and 29.

In one nonlimiting configuration, a method of assembling a solar tracker can include forming a concrete track; and establishing a staging area at one end of the concrete track. The method also can include building a tracker structure on a cart at the staging area; and moving the cart along the concrete track to a location where the tracker structure is to be installed. The method also can include removing the tracker structure from the cart and placing the tracking structure on the concrete track; and connecting a coupling of the tracker structure to a coupling of an adjacent tracker structure. The method also can include securing the tracker structure in place on the concrete track; and fastening one or more solar panels to the tracker structure. Nonlimiting examples of such a method are provided herein with reference to FIGS. 20, 24, 25, and 27A-27D.

While various illustrative embodiments of the invention are described herein, it will be apparent to one skilled in the art that various changes and modifications may be made therein without departing from the invention. For example, the present systems and methods are not limited to use with photovoltaic modules, and instead can be applied to solar collectors including any type of solar module (e.g., a module such as used with a concentrated solar power system, such as a parabolic trough or heliostat), or to rotating and locking any other type of structure. All such changes and modifications that fall within the true spirit and scope of the invention are encompassed by the following claims.

1. A system for rotatably mounting and locking a solar panel, the system comprising:
a drive mechanism comprising a drive shaft, a pinion gear, and an arc gear,
the pinion gear being coupled to the drive shaft and comprising pinion gear teeth and a bearing surface,
the arc gear being coupled to the solar panel and comprising a first section, the first section comprising arc gear teeth; and
a locking mechanism comprising a lock plate coupled to the arc gear and comprising a reaction surface;
wherein, responsive to rotation of the drive shaft by a first amount, engagement of the pinion gear teeth with the arc gear teeth in the first section rotates the arc gear; and
wherein, responsive to rotation of the drive shaft by a second amount, the arc gear rotates to a stow position at which the reaction surface bears against the bearing surface and locks the arc gear in place.

2. The system of claim 1, wherein:
the locking mechanism further comprises a drive pin coupled to the pinion gear;
the lock plate further comprises a slot configured to engage the drive pin; and
responsive to rotation of the drive shaft by a third amount, the slot of the lock plate engages with the drive pin responsive to which the arc gear teeth disengage from the pinion gear teeth.

3. The system of claim 1, wherein the arc gear further comprises a second section lacking arc gear teeth, the lock plate being coupled adjacent to the second section.

4. The system of claim 2, further comprising a leg and a bearing mount coupled to the leg, the bearing mount supporting the drive shaft and the pinion gear.

5. The system of claim 4, wherein when the arc gear is at the stow position, bearing of the reaction surface against the bearing surface substantially transmits a wind load on the solar panel into the leg via the bearing mount.

6. The system of claim 5, wherein the arc gear comprises a first piece of metal forming sidewalls and a second piece of sheet metal forming a gear tooth strip, the gear tooth strip interlocking with the sidewalls.

7. The system of claim 3, wherein the system is coupled to a first purlin supporting a first plurality of solar panels, the rotation of the arc gear to the stow position locking the first plurality of solar panels in a fixed position.

8. A system for rotatably mounting and locking a plurality of solar trackers, the system comprising:
a first mechanism coupled to a first solar tracker; and
a second mechanism coupled to a second solar tracker;
the first and second mechanisms each comprising:
a drive mechanism comprising a drive shaft, a pinion gear, and an arc gear,
the pinion gear being coupled to the drive shaft and comprising pinion gear teeth, and
the arc gear being coupled to the corresponding solar tracker and comprising a first section, the first section comprising arc gear teeth; and
a locking mechanism comprising a lock plate and a drive pin,
the drive pin being coupled to the pinion gear, and
the lock plate being coupled to the arc gear and comprising a slot configured to engage the drive pin;
wherein the drive shaft of the first mechanism is flexibly coupled to the drive shaft of the second mechanism;
wherein, responsive to rotation of the first drive shaft by a first amount:
engagement of the pinion gear teeth of the first mechanism with the arc gear teeth in the first section of the first mechanism rotates the arc gear of the first mechanism;
the second drive shaft rotates by the first amount via the flexible coupling; and
engagement of the pinion gear teeth of the second mechanism with the arc gear teeth in the first section of the second mechanism rotates the arc gear of the second mechanism; and
wherein, responsive to rotation of the first drive shaft by a second amount:
the slot of the lock plate of the first mechanism engages with the drive pin of the first mechanism and the arc gear teeth of the first mechanism disengage from the pinion gear teeth of the first mechanism;
the second drive shaft rotates by the second amount via the flexible coupling; and
the slot of the lock plate of the second mechanism engages with the drive pin of the second mechanism and the arc gear teeth of the second mechanism disengage from the pinion gear teeth of the second mechanism.

9. The system of claim 8, wherein:
the pinion gear of each of the first and second mechanisms further comprises a bearing surface,
the lock plate of each of the first and second mechanisms further comprises a reaction surface,
responsive to rotation of the first drive shaft by a third amount and the engagement between the slot of the lock plate of the first mechanism with the drive pin of the first mechanism:
the arc gear of the first mechanism rotates to a stow position at which the reaction surface of the first mechanism bears against the bearing surface of the first mechanism,
the second drive shaft rotates by the third amount via the flexible coupling, and
the arc gear of the second mechanism rotates to a stow position at which the reaction surface of the second mechanism bears against the bearing surface of the second mechanism.

10. The system of claim 8, wherein the arc gear of each of the first and second mechanisms further comprises a second section lacking arc gear teeth, the lock plate being coupled adjacent to the second section.

11. The system of claim 8, wherein the rotation of the arc gear of the first mechanism to the stow position occurs at a different time than the rotation of the arc gear of the second mechanism to the stow position.

12. A method for rotatably mounting and locking a solar panel, the method comprising:
providing a drive mechanism comprising a drive shaft, a pinion gear, and an arc gear,
the pinion gear being coupled to the drive shaft and comprising pinion gear teeth and a bearing surface,
the arc gear being coupled to the solar panel and comprising a first section, the first section comprising arc gear teeth;
providing a locking mechanism comprising a lock plate coupled to the arc gear and comprising a reaction surface;
rotating the drive shaft by a first amount such that engagement of the pinion gear teeth with the arc gear teeth in the first section rotates the arc gear; and
rotating the drive shaft by a second amount while engaging the slot of the lock plate with the drive pin such that the arc gear rotates to a stow position at which the reaction surface bears against the bearing surface and locks the arc gear in place.

13. The method of claim 12, wherein:
the locking mechanism further comprises a drive pin coupled to the pinion gear;
the lock plate further comprises a slot configured to engage the drive pin; and
the method includes rotating the drive shaft by a third amount such that the slot of the lock plate engages with the drive pin responsive to which the arc gear teeth disengage from the pinion gear teeth.

14. The method of claim 12, wherein the arc gear further comprises a second section lacking arc gear teeth, the lock plate being coupled adjacent to the second section.

15. The method of claim 13, wherein the method further comprises providing a leg and a bearing mount coupled to the leg, the bearing mount supporting the drive shaft and the pinion gear.

16. The method of claim 15, the method further including, when the arc gear is at the stow position, the bearing of the reaction surface against the bearing surface substantially transmits a wind load on the solar panel into the leg via the bearing mount.

17. The method of claim 12, wherein the arc gear comprises a first piece of metal forming sidewalls and a second piece of metal forming a gear tooth strip, the gear tooth strip interlocking with the sidewalls.

18. The method of claim 14, wherein the mechanism is coupled to a first purlin supporting a first plurality of solar panels, the rotation of the arc gear to the stow position locking the first plurality of solar panels in a fixed position.

19. A method for rotatably mounting and locking a plurality of solar trackers, the method comprising:
providing a first mechanism coupled to a first solar tracker;
providing a second mechanism coupled to a second solar tracker;
wherein the first and second mechanisms each comprise:
a drive mechanism comprising a drive shaft, a pinion gear, and an arc gear,
the pinion gear being coupled to the drive shaft and comprising pinion gear teeth, and
the arc gear being coupled to the corresponding solar tracker and
comprising a first section, the first section comprising arc gear teeth; and
a locking mechanism comprising a lock plate and a drive pin,
the drive pin being coupled to the pinion gear, and
the lock plate being coupled to the arc gear and comprising a slot configured to engage the drive pin;
wherein the drive shaft of the first mechanism is flexibly coupled to the drive shaft of the second mechanism;
rotating the first drive shaft by a first amount such that engagement of the pinion gear teeth of the first mechanism with the arc gear teeth in the first section of the first mechanism rotates the arc gear of the first mechanism;
rotating the second drive shaft by the first amount via the flexible coupling such that engagement of the pinion gear teeth of the second mechanism with the arc gear teeth in the first section of the second mechanism rotates the arc gear of the second mechanism; and
rotating the first drive shaft by a second amount such that the slot of the lock plate of the first mechanism engages with the drive pin of the first mechanism and the arc gear teeth of the first mechanism disengages from the pinion gear teeth of the first mechanism; and
rotating the second drive shaft by the second amount via the flexible coupling such that the slot of the lock plate of the second mechanism engages with the drive pin of the second mechanism and the arc gear teeth of the second mechanism disengage from the pinion gear teeth of the second mechanism.

20. The method of claim 19, wherein:
the pinion gear of each of the first and second mechanisms further comprises a bearing surface,
the lock plate of each of the first and second mechanisms further comprises a reaction surface,
the method further comprising:
rotating the first drive shaft by a third amount while engaging the slot of the lock plate of the first mechanism with the drive pin of the first mechanism such that the arc gear of the first mechanism rotates to a stow position at which the reaction surface of the first mechanism bears against the bearing surface of the first mechanism; and
rotating the second drive shaft by the third amount via the flexible coupling such that the arc gear of the second mechanism rotates to a stow position at which the reaction surface of the second mechanism bears against the bearing surface of the second mechanism.

21. The method of claim 19, wherein the arc gear of each of the first and second mechanisms further comprises a second section lacking arc gear teeth, the lock plate being coupled adjacent to the second section.

22. The method of claim 19, wherein the rotation of the arc gear of the first mechanism to the stow position occurs at a different time than the rotation of the arc gear of the second mechanism to the stow position.

23-24. (canceled)
